(19) United States
(12) Patent Application Publication
(10) Pub. No.: US 2008/0293277 A1
(43) Pub. Date: Nov. 27, 2008

(54) SYSTEM AND METHOD FOR CONNECTING A BATTERY TO A MOUNTING SYSTEM

(76) Inventors: Ajith Kuttannair Kumar, Erie, PA (US); Michael Patrick Marley, Erie, PA (US); Stephen Pelkowski, Erie, PA (US); Robert Alton, Lawrence Park, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/752,488

(22) Filed: May 23, 2007

(51) Int. Cl. H01R 13/64

(52) U.S. Cl. 439/247

(57) ABSTRACT

A system is provided for connecting a battery to a mounting system. The battery is coupled to a battery connector, and the mounting system is coupled to a mounting system connector. The system includes an inner housing of the battery connector configured to receive a plurality of cables from the battery. The system further includes a respective plurality of male connectors or female receptacles positioned within the inner housing of the battery connector and coupled to the plurality of cables. The plurality of male connectors or female receptacles is configured to remain unexposed upon disconnecting the battery connector from the mounting connector during an unsafe event. The system further includes an outer housing of the battery connector surrounding the inner housing, where the outer housing includes a tapered wall.

### FIELD OF THE INVENTION

The present invention relates to batteries, and more particularly, to a system and method for electrically connecting a battery to load or power source.

### BACKGROUND OF THE INVENTION

Hybrid energy vehicles, such as hybrid diesel electric locomotives, for example, may include several batteries, such as between ten and fifty, for example. Each battery may be a large massive body, typically weighing several hundred pounds, and thus requiring intricate handling on rails or with a crane, for example, during transportation to the locomotive for connection. Each battery typically includes a battery connector, which receives a plurality of battery cables from the battery and connects with a corresponding locomotive connector mounted to the hybrid energy locomotive.

In connecting each battery to the locomotive, the battery is typically supported and moved along a rail in the direction of the locomotive connector until an electrical connection is established between the battery connector and locomotive connector. However, the battery connector and locomotive connector typically include corresponding male and female mating connectors, which need to respectively align before the battery connector and locomotive connector can properly connect. Thus, the battery connector needs to be properly aligned with the locomotive connector as it is moved in the direction of the locomotive connector, so to ensure proper alignment of the male and female mating connectors. However, conventional battery connection systems provide limited alignment tolerance in both the axial and tilt dimensions, and thus inherently limit the ability to properly connect the battery connector and locomotive connector. Improperly aligned connectors can result in damaged batteries/energy systems and/or poor system performance.

Upon connecting the battery connector of each battery to the locomotive connector, an unsafe condition may arise, such as a high current passing through the connectors to fuse the male and female connectors together, for example. In conventional battery connection systems, upon attempting to disconnect the battery connector from the locomotive connector subsequent to such an unsafe condition, the male and female mating connectors may remain fused together and the battery cables may disconnect from their respective mating connectors within the battery connector and remain exposed, thereby creating a safety hazard. As appreciated by one of skill in the art, the battery power cannot be turned off, and thus the exposed battery cables will remain at high potential.

Accordingly, it would be advantageous to provide a battery connector to provide increased alignment tolerance, including in the three primary axis and tilt dimensions, for example, when connecting the battery connector and locomotive connector. Additionally, it would be advantageous to provide a battery connector, such that upon disconnecting the battery connector from the locomotive connector subsequent to an unsafe condition, the battery cables remain unexposed within the battery connector, thereby eliminating any safety hazard. The connector is set up in such a way that the receptacles will always remain unexposed upon disconnection, not just subsequent to an unsafe event.

### BRIEF DESCRIPTION OF THE INVENTION

In one embodiment of the present invention, a system is provided for connecting a battery to a mounting system. The battery is coupled to a battery connector, and the mounting system is coupled to a mounting system connector. The system includes an inner housing of the battery connector configured to receive a plurality of cables from the battery. The system further includes a respective plurality of male connectors or female receptacles positioned within the inner housing of the battery connector and coupled to the plurality of cables. The plurality of male connectors or female receptacles is configured to remain unexposed upon disconnecting the battery connector from the mounting connector during a normal and/or an unsafe event. The battery connector is configured such that the male connectors or female receptacles will remain unexposed upon disconnection from the mounting system, and not just subsequent to an unsafe event. The system further includes an outer housing of the battery connector surrounding the inner housing, where the outer housing includes a tapered wall.

In one embodiment of the present invention, a system is provided for connecting a battery to a mounting system. The battery is coupled to a battery connector, and the mounting system is coupled to a mounting system connector. The system includes an inner housing of the battery connector configured to receive a plurality of cables from the battery. The system further includes a respective plurality of first male connectors or first female receptacles coupled to the plurality of cables and positioned adjacent to a back end of the inner housing of the battery connector. The plurality of first male connectors or first female receptacles are coupled to a respective plurality of second male connectors or second female receptacles through a respective plurality of links which may be fused links. The plurality of second male connectors or second female receptacles are configured to break away from the inner housing, and the plurality of first male connectors or first female receptacles are configured to remain unexposed upon disconnecting the battery connector from the mounting connector during an unsafe event. The system further includes an outer housing of the battery connector surrounding the inner housing, where the outer housing includes a tapered wall.

In one embodiment of the present invention, a method is provided for connecting a battery to a mounting system. The battery is coupled to a battery connector, and the mounting system is coupled to a mounting system connector. The method includes receiving a plurality of cables from the battery into an inner housing of the battery connector, and surrounding the inner housing of the battery connector with an outer housing including a tapered wall. The method further includes coupling a respective plurality of male connectors or female receptacles within the inner housing to the plurality of cables. The method further includes configuring the plurality of male connectors or female receptacles of the battery connector to remain unexposed while disconnecting the battery connector from the mounting connector during an unsafe event.

In one embodiment of the present invention, a method is provided for self-aligning a battery connector to a mounting system connector during connecting the battery connector and the mounting system connector. The method includes tapering a wall of an outer housing of the battery connector and the mounting system connector. The tapered wall has a respective tapered outer surface or tapered inner surface, which are respectively configured to self-align upon connecting the battery connector and the mounting system. The method further includes positioning a portion of the outer housing of the battery connector and the mounting system connector between a plurality of collars. The method further includes passing a bolt through the collars to permit self-alignment of the outer housing of the battery connector and the mounting system within the plane of the collars during the self-aligning of the battery connector and the mounting system. The method further includes tapering a plurality of slots within an inner housing of the battery connector and hybrid energy locomotive connector, where the tapered slots are configured to provide axial tolerance during the self-alignment of the battery connector and the hybrid energy locomotive connector.

### BRIEF DESCRIPTION OF THE DRAWINGS

A more particular description of the embodiments of the invention briefly described above will be rendered by reference to specific embodiments thereof that are illustrated in the appended drawings. Understanding that these drawings depict only typical embodiments of the invention and are not therefore to be considered to be limiting of its scope, the embodiments of the invention will be described and explained with additional specificity and detail through the use of the accompanying drawings in which:

FIG. 1 is a cross-sectional plan view of an embodiment of a system for cooling an energy storage system of a hybrid electric vehicle;

FIG. 2 is a cross-sectional plan view of an embodiment of a system for cooling an energy storage system of a hybrid electric vehicle;

FIG. 3 is a flow chart illustrating an exemplary embodiment of a method for cooling an energy storage system of a hybrid electric vehicle;

FIG. 4 is a cross-sectional side view and cross-sectional end view of an embodiment of a system for cooling an energy storage system of a hybrid electric vehicle;

FIG. 5 is a cross-sectional side view and cross-sectional end view of an embodiment of a system for cooling an energy storage system of a hybrid electric vehicle;

FIG. 6 is a cross-sectional side view and cross-sectional end view of an embodiment of a system for cooling an energy storage system of a hybrid electric vehicle;

FIG. 7 is a cross-sectional side view and cross-sectional end view of an embodiment of a system for cooling an energy storage system of a hybrid electric vehicle;

FIG. 8 is a cross-sectional side view of an embodiment of a system for cooling an energy storage system of a hybrid electric vehicle;

FIG. 9 is a cross-sectional top view of an embodiment of a system for cooling an energy storage system of a hybrid electric vehicle;

FIG. 10 is an exemplary embodiment of a method for cooling an energy storage system of a hybrid electric vehicle;

FIG. 11 is an exemplary embodiment of a method for cooling an energy storage system of a hybrid electric vehicle;

FIG. 12 is a cross-sectional side view of an embodiment of a system for cooling an energy storage system of a hybrid electric vehicle;

FIG. 13 is a timing diagram illustrating an embodiment of a maximum temperature and minimum temperature of a maximum temperature storage device and minimum temperature storage device of an embodiment of a cooling system for an energy storage system;

FIG. 14 is a timing diagram illustrating an embodiment of a maximum temperature and minimum temperature of a maximum temperature storage device and minimum temperature storage device of an embodiment of a cooling system for an energy storage system;

FIG. 15 is a block diagram of an exemplary embodiment of an energy storage system;

FIG. 16 is an exemplary embodiment of a method for cooling an energy storage system of a hybrid electric vehicle;

FIG. 17 is an exemplary embodiment of a method for cooling an energy storage system of a hybrid electric vehicle;

FIG. 18 is a side plan view of an embodiment of a system for connecting a battery to a hybrid energy locomotive;

FIG. 19 is a partial cross-sectional side view of an embodiment of a system for connecting a battery to a hybrid energy locomotive;

FIG. 20 is a cross-sectional end view of an embodiment of a system for connecting a battery to a hybrid energy locomotive;

FIG. 20A is a detailed cross-sectional end view of a female receptacle of the embodiment of a system for connecting a battery to a hybrid energy locomotive illustrated in FIG. 20;

FIG. 21 is a partial perspective plan view of a system for connecting a battery to a hybrid energy locomotive;

FIG. 22 is a cross-sectional end view of an embodiment of a system for connecting a battery to a hybrid energy locomotive;

FIG. 23 is a cross-sectional end view of an embodiment of a system for connecting a battery to a hybrid energy locomotive;

FIG. 24 is a cross-sectional end view of an embodiment of a system for connecting a battery to a hybrid energy locomotive;

FIG. 25 is a cross-sectional end view of an embodiment of a system for connecting a battery to a hybrid energy locomotive;

FIG. 26 is a detailed cross-sectional end view of the embodiment of a system for connecting a battery to a hybrid energy locomotive illustrated in FIG. 25;

FIG. 27 is a cross-sectional end view of an embodiment of a system for connecting a battery to a hybrid energy locomotive;

FIG. 28 is a detailed cross-sectional end view of the embodiment of a system for connecting a battery to a hybrid energy locomotive illustrated in FIG. 27;

FIG. 29 is an exemplary embodiment of a method for connecting a battery to a mounting system;

FIG. 30 is an exemplary embodiment of a method for self-aligning a battery connector to a mounting system connector while connecting the battery connector to the mounting system connector.

### DETAILED DESCRIPTION OF THE INVENTION

Though exemplary embodiments of the present invention are described with respect to rail vehicles, specifically hybrid trains and locomotives having diesel engines, the exemplary embodiments of the invention discussed below are also applicable for other uses, such as but not limited to hybrid diesel electric off-highway vehicles, marine vessels, and stationary units, each of which may use a diesel engine for propulsion and an energy storage system with one or more energy storage devices. Additionally, the embodiments of the present invention discussed below are similarly applicable to hybrid vehicles, whether they are diesel-powered or non-diesel powered, including hybrid locomotives, hybrid off-highway vehicles, hybrid marine vehicles, and stationary applications. Yet further, the embodiments of the present application are applicable to any battery applications, whether or not such applications are performed on the hybrid powered vehicles described above. Additionally, although the embodiments of the present application discuss the use of outside air and cooling air drawn into an air inlet and through an air duct, any cooling fluid appreciated by one of skill in the art other than air may be utilized in place of the cooling air or outside air discussed in the embodiments of the present application.

With regard to those embodiments of the present invention discussing battery connectors, such battery connectors may be utilized to connect one or more batteries to any mounting surface to advantageously provide a hands-free connection and where such a mounting surface includes a connector compatible with the battery connector. Accordingly, these battery connectors may be connected to various mounting surfaces, stationary or non-stationary, other than locomotives. Additionally, those embodiments of the present invention discussing battery connectors may be similarly applied to other electrical devices, where the connector is coupled to an electrical device other than a battery, and connects the electrical device to the mounting system. Such electrical devices may include capacitors, ultra-capacitors, or any other high-energy/high-voltage device, for example.

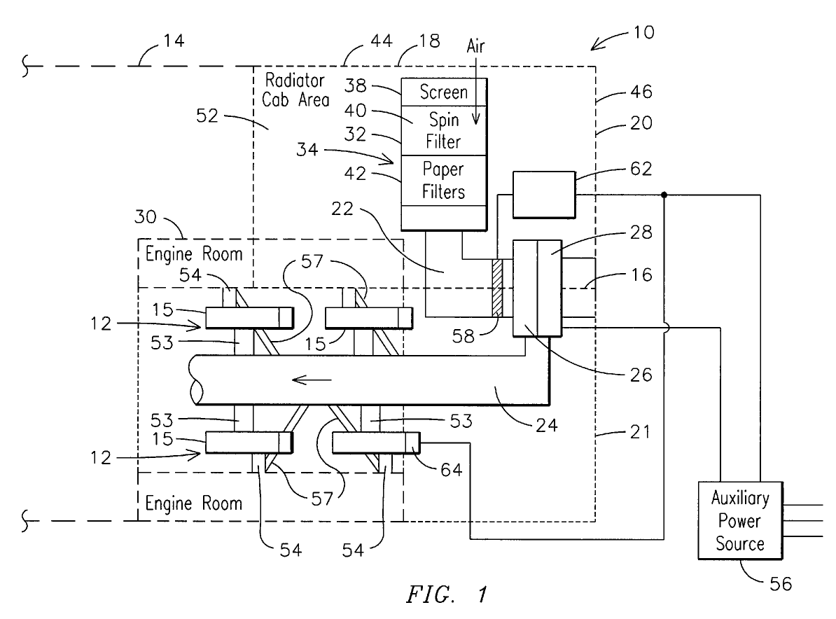

FIG. 1 illustrates one embodiment of a system 10 for cooling an energy storage system 12 of a hybrid diesel electric locomotive 14. The energy storage system 12 illustratively includes a plurality of energy storage devices (i.e., batteries) 15 positioned below a platform 16 of the locomotive 14. Although FIG. 1 illustrates the energy storage devices 15 positioned below the platform 16, the energy storage devices 15 may be positioned above or on the locomotive platform 16, such as for a tender application, as appreciated by one of skill in the art, for example. In an exemplary embodiment of the system 10, the platform 16 of the locomotive 14 is positioned above the wheels of the locomotive and is substantially aligned with the floor of the operator cabin for each locomotive, as appreciated by one of skill in the art. However, the platform 16 may be aligned with other horizontal surfaces of the locomotive 14 other than the operator cabin.

In the illustrated exemplary embodiment of FIG. 1, the system 10 includes an air inlet 18 positioned on an outer surface 20 of the locomotive 14 above the platform 16 at a location relatively free from contamination, including diesel fumes, hot air exhaust, etc. The air inlet 18 is an opening in the outer surface 20 of the locomotive 14 adjacent to a radiator area 52 of the locomotive 14, with dimensions based upon the particular energy storage system 12 and the cooling air flow demand for each energy storage system. Although FIG. 1 illustrates the air inlet 18 positioned in an opening of the outer surface 20 adjacent to the radiator area 52, the air inlet 18 may be positioned in an opening of the outer surface 20 adjacent to any area of the locomotive, above the platform 16. In an additional exemplary embodiment, the air inlet 18 may be positioned at any location along the outer surface 20,21, above or below the locomotive platform 16, provided that the incoming outside air into the inlet 18 contains a minimum amount of contaminants. By positioning the air inlet 18 along the outer surface 20 of the locomotive 14 above the platform 16, outside air drawn into the air inlet includes a substantially less amount of contaminants relative to outside air adjacent to an outer surface 21 of the locomotive below the platform 16. Although FIG. 1 illustrates an air inlet 18 positioned on a roof portion 44 of the outer surface 20 of the locomotive 14, the air inlet may be positioned at any location along the outer surface 20 of the locomotive 14 above the platform 16, including at any location on the roof portion 44 or side portions 46 of the outer surface 20 above the platform 16. Additionally, although FIG. 1 illustrates one air inlet 18 positioned in the outer surface 20 of the locomotive 14 above the platform 16, more than one air inlet 18 may be positioned in the outer surface 20 of the locomotive 14.

As further illustrated in the exemplary embodiment of FIG. 1, filtering media 32 are positioned at a filtering location 34 adjacent to the air inlet 18 within an air inlet duct 22. The filtering media 32 assist in removing contaminants from the outside air drawn into the air inlet 18 before it enters the air inlet duct 22. Although FIG. 1 illustrates a variety of filtering media 32, including more than one filtering layers, such as a screen 38, a spin filter 40 and a paper filter 42, any type of filtering media may be utilized. Additionally, since the exemplary embodiment of the system 10 features placement of the air inlet 18 along the outer surface 20 of the locomotive above the locomotive platform 16, the amount of contaminants in the incoming outside air through the air inlet is relatively low, thereby minimizing the need for excessive filtering, and/or extending the life of filter and battery components. Screen filters 38 may be placed as a first filtering layer encountered by incoming outside air to remove large objects, such as leaves and paper, for example. Spin filters 40 may be placed as a second filtering layer for the incoming outside air to separate matter based upon density using an air spinning centrifuge device, for example. Additionally, paper filters 42 may be utilized as an additional filtering layer to collect additional particles from the outside air during the filtering process, for example. Since the exemplary embodiment of the system 10 features a single filtering location 34 for all filtering media 32, regular maintenance including regular replacement and/or cleaning of each filtering media may be conveniently accomplished at the single filtering location, as oppose to at multiple filtering locations.

As further illustrated in the exemplary embodiment of FIG. 1, the system 10 includes the air inlet duct 22 and an air duct 24 in flow communication with the air inlet 18. The filtering media 32 is disposed between the air inlet duct 22 and the air inlet 18. The air duct 24 is coupled to the air inlet duct 22 through a blower 26 and motor 28 (discussed below) and a damper control device 58 (discussed below). Although FIG. 1 illustrates a blower 26 and respective motor 28, each blower 26 may be directed driven by a mechanical source, or each blower 26 may be driven by a second blower which in turn may be driven by a mechanical source. While the air inlet duct 22 is illustratively positioned above the locomotive platform 16, the air duct 24 is illustratively positioned below the locomotive platform 16. However, the air inlet duct and air duct are not limited to being respectively positioned above and below the locomotive platform. Additionally, although FIG. 1 illustrates one air inlet duct and one air duct, more than one air inlet may be positioned along the outer surface, for which more than one respective air inlet duct and air duct may be utilized.

The air duct 24 illustrated in the exemplary embodiment of FIG. 1 passes along the length of the locomotive 14, and is in flow communication with each energy storage device 15 below the locomotive platform 16. Although FIG. 1 illustrates four energy storage devices positioned on opposite sides of the air duct, any number of energy devices may be in flow communication with the air duct, including on opposing sides of the air duct or on one side of the air duct, for example. Additionally, although FIG. 1 illustrates one air duct positioned below the locomotive platform 16, more than one air duct may be positioned below the platform, and thus more than one set of energy storage devices may be respectively in flow communication with each respective air duct.

As further illustrated in the exemplary embodiment of FIG. 1, the system 10 includes a blower 26 powered by a motor 28 positioned within the air inlet duct 22. During operation, upon supplying power to the motor 28 and activating the blower 26, the blower draws outside air from above the locomotive platform 16 into the air inlet 18, through the filtering media 32 at the single filtering location 34 and through the air inlet duct 22 and the air duct 24. The blower 26 subsequently passes the outside air over or through each energy storage device 15 and into a common vented area 30 of the locomotive 14. In the illustrated exemplary embodiment of FIG. 1, the common vented area 30 is an engine compartment area, which receives a substantial amount of heat from the locomotive engine, as appreciated by one of skill in the art. The blower 26 forces the outside air through a duct coupling 53 to pass the outside air over or through each energy storage device 15 and further draws the outside air through a respective vent coupling 54 to the engine compartment 30. The engine compartment 30 includes one or more pre-existing vents (not shown) along the outer surface of the locomotive 14, to exhaust the outside air outside the locomotive upon entering the engine compartment. Although FIG. 1 illustrates one blower and a respective motor, more than one blower and respective motor may be utilized within each air duct, or alternatively one blower and respective motor may be positioned within each of a plurality of air ducts, as discussed above. As illustrated in the exemplary embodiment of FIG. 1, a secondary duct 57 is illustratively coupled between the air duct 24 and each vent coupling 54 between each energy storage device 15 and the engine compartment area 30. The secondary duct 57 is provided to pass cooler outside air from the air duct 24 into each vent coupling 54, to blend the cooler outside air with hotter outside air having passed over or through each energy storage device 15 and into each vent coupling 54. Within each vent coupling 54, the cooler outside air from each air duct 24 blends with the hotter cooler air having passed over or through each energy storage device 15, thereby reducing the temperature of the outside air passed to the engine compartment area 30. Additionally, in an exemplary embodiment, a secondary duct 57 may be positioned to blend cooler outside air from the air duct 24 with a respective vent external to the locomotive (not shown). In the exemplary embodiment of utilizing the secondary duct, a greater amount of cooler outside air may be blended with the hotter outside air having passed over or through each energy storage device when the outside air is exhausted outside of the locomotive, as the outside air has a greater likelihood to come into human contact, thus presenting a safety issue if the temperature of the exhausted outside air is at an unacceptably high level.

As illustrated in the exemplary embodiment of FIG. 1, the system 10 includes a power source 56 to supply power to the blower 26 and motor 28. In the exemplary embodiment, the power source 56 is an auxiliary power source to supply power to the blower 26 and motor 26 to draw the outside air into the air inlet 18, through the filtering media 32, through the air inlet duct 22 and the air duct 24, to pass the outside air over or through each energy storage device 15 and into the common vented area 30 of the locomotive 14. In an exemplary embodiment, the blower 26 is operated continuously to avoid non-rotation of the blower motor for an extended period of time during operation of the locomotive 14 to prevent failure of a motor bearing of the blower 26 due to mechanical vibrations during the operation of the locomotive 14.

In addition to the power source 56, a damper control device 58 may be positioned within the air inlet duct 22 to selectively shut off the supply of outside air to the blower 26. The damper control device 58 may be controlled by a locomotive controller 62, and is switchable between an open (outside air supply flows to the blower 26) and closed (outside air supply is shut off to the blower 26) position. The locomotive controller 62 is illustratively coupled to the damper control device 58, and switches the damper control device between the open and closed position based upon the temperature of each energy storage device 15, which the locomotive controller reads from a respective temperature sensor 64, such as a thermometer, for example, of each energy storage device also coupled to the locomotive controller. Additionally, the locomotive controller 62 may switch the damper control device to an intermediate position between the open and closed position, to control the supply of outside air flowing to the blower 26. To maximize the efficiency of the system 10, the locomotive controller 62 may switch the damper control device 58 to the closed position, such that the blower continues to rotate (assuming the motor is receiving power) but no outside air is supplied to the blower, thereby minimizing any work done by the blower. In an exemplary embodiment, the operating temperature range of the energy storage device may be between 270-330 degrees Celsius, for example, however the locomotive controller may turn the damper control device to the closed position upon reading a minimum temperature of 270 degrees Celsius from each of the energy storage devices, and shut off the supply of outside air to the blower, thereby shutting off the cooling system, for example. The exemplary temperature range of 270-330 degrees Celsius is merely an example, and energy storage devices operate at varying temperature ranges. Additionally, the locomotive controller may turn the damper control device to the open position upon reading a maximum temperature of 300 degrees Celsius from each of the energy storage devices, and reopen the supply of outside air to the blower to recommence the cooling system, for example. Although FIG. 1 illustrates one power source and damper control device, more than one power source and more than one damper control device may be utilized. Although the illustrated power source 56 is an auxiliary power source, the motor 28 may be powered by a locomotive engine power source. The locomotive controller 62 is included in the illustrated exemplary embodiment of the system 10 to monitor a temperature sensor 64 coupled to each energy storage device 15. In addition to selectively operating the damper control system, the locomotive controller 62 may selectively operate a continuous speed blower, a multiple speed blower of the speed of the power source 56, a variable speed blower/direct driven blower or a switchable blower. The locomotive controller 62 may selectively operate each blower based upon comparing a monitored temperature from the temperature sensor 64 of each energy storage device 15 with a respective predetermined temperature threshold of each energy storage device 15 stored in the locomotive controller memory.

The blower 26 may be a continuous speed blower, a multiple speed blower of the speed of the power source 56, or a switchable blower including a switch to turn the blower on and off. For example, the multiple speed blower may operate at multiple speeds (i.e., ½, ¼, ⅛, etc) of the speed of the power source to the blower, or a variable speed drive like an inverted driven motor.

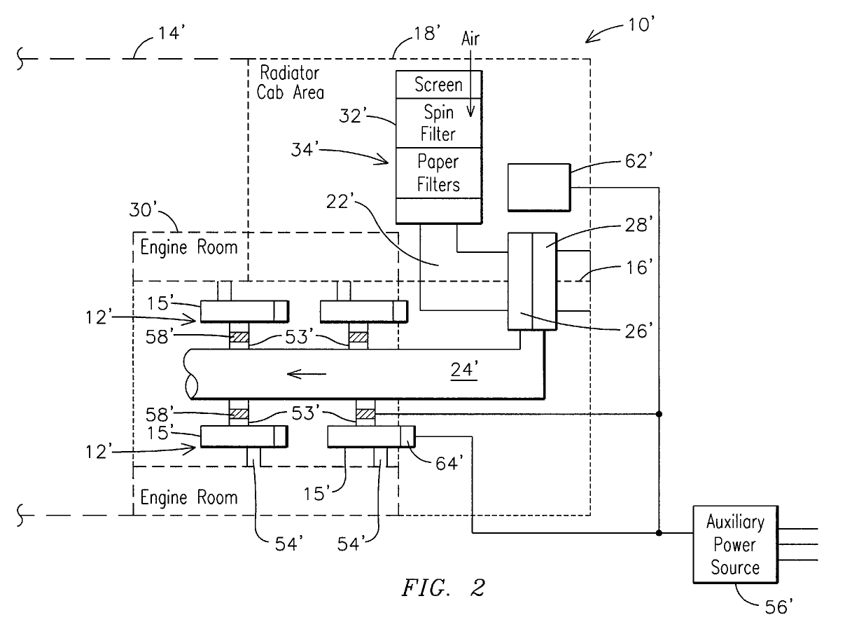

FIG. 2 illustrates another embodiment of a system 10′ for cooling an energy storage system 12′. The system 10′ includes an air inlet duct 22′ and air duct 24′ in flow communication to the air inlet 18′. As illustrated in the exemplary embodiment of FIG. 2, the system 10′ includes a power source 56′ to controllably operate the blower 26′ and motor 28′. In the exemplary embodiment, the power source 56′ includes an auxiliary power source to controllably operate the blower 26′ and motor 28′ to draw the outside air into the air inlet 18′, through the filtering media 32′ and through the air inlet duct 22′ and the air duct 24′. Upon passing through the air duct 24′, the outside air passes through a respective damper control device 58′ positioned within the duct coupling 53′ from the air duct 24′ to each energy storage device 15′. Each damper control device 58′ is positioned within the duct coupling 53′ adjacent to each energy storage device 15′ to selectively shut off the supply of outside air to each energy storage device. Each damper control device 58′ is controlled by the locomotive controller 62′ to selectively shut off the supply of outside air over or through each energy storage device 15′, through a respective vent coupling 54′ and into a common vented area 30′, such as the engine compartment, for example. Each damper control device 58′ is switchable by the locomotive controller 62′ between an open (outside air supply flows to each energy storage device 15′) and closed (outside air supply is shut off to each energy storage device 15′) position. Additionally, the controller 62′ may switch the damper control device 58′ to an intermediate position between the open and closed positions, to selectively control the supply of outside air provided to each energy storage device 15′. The locomotive controller 62′ is illustratively coupled to each damper control device 58′, and switches the damper control device between the open and closed position based upon the temperature of each energy storage device 15′, which is read from a respective temperature sensor 64′ of each energy storage device that is also coupled to the locomotive controller. In an exemplary embodiment, the operating temperature range of the energy storage device may be 270-330 degrees Celsius, however the locomotive controller may turn the damper control device to the closed position upon reading a minimum temperature of 270 degrees Celsius from each of the energy storage devices, and shut off the supply of outside air to the energy storage device. The example of a temperature range of 270-330 degrees Celsius is merely exemplary and energy storage devices may operate at varying temperature ranges. Additionally, the locomotive controller may turn the damper control device to the open position upon reading a minimum temperature of 300 degrees Celsius from each of the energy storage devices, and reopen the supply of outside air to each energy storage device. Although FIG. 2 illustrates one power source and one damper control device for each energy storage device, more than one power source and more than one damper control device for each energy storage device may be utilized. Although the illustrated power source 56′ is an auxiliary power source, the motor 28′ may be powered by a locomotive engine power source. Those other elements of the system 10′ not discussed herein, are similar to those elements of the previous embodiments discussed above, without prime notation, and require no further discussion herein.

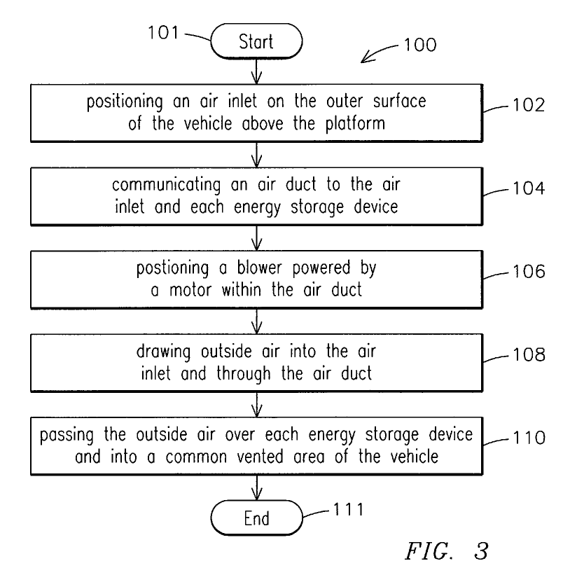

FIG. 3 illustrates an exemplary embodiment of a method 100 for cooling an energy storage system 12 of a hybrid diesel electric locomotive 14. The energy storage system 12 includes a plurality of energy storage devices 15 positioned below a platform 16 of the locomotive 14. The energy storage devices 15 may be similarly positioned above the platform 16 of the locomotive or other vehicles 14. The method 100 begins (block 101) by positioning (block 102) an air inlet on the outer surface of the vehicle above the platform. More particularly, the method includes communicating (block 104) an air duct to the air inlet and each energy storage device. Additionally, the method includes positioning (block 106) a blower powered by a motor within the air duct. The method further includes drawing (block 108) outside air into the air inlet and through the air duct, followed by passing (block 110) the outside air over or through each energy storage device and into a common vented area of the vehicle, before ending at block 111.

The method may further include providing filtering media 32 at a filtering location 34 adjacent to the air inlet 18 within an air inlet duct 22 in flow communication to the air duct 24, where the filtering media 32 may include a filtering screen 38, a spin filter 40, a paper filter 42, and any other type of filtering media known to one of skill in the art. Additionally, the method may further include removing contaminants from the outside air before entering the air inlet duct 18. The method may further include positioning a damper control device 58 within the air inlet duct 22 to selectively shut off the supply of outside air to each energy storage device 15.

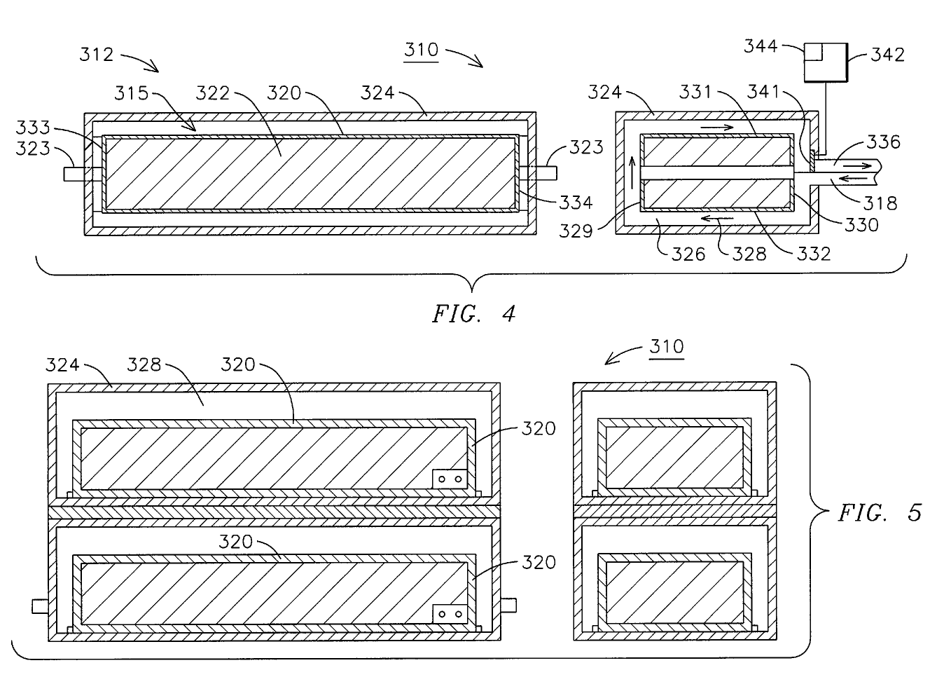

FIG. 4 illustrates an additional embodiment of a system 310 for cooling an energy storage system 312, where the energy storage system 312 includes one or more energy storage devices 315. Although FIG. 4 illustrates one energy storage device, the system 310 may be utilized with a plurality of energy storage devices 315, as illustrated in FIG. 5.

The system 310 illustratively includes an inner casing 320 configured to encapsulate an inner core 322 of the energy storage device 315 of the energy storage system 312. The inner core 322 of the energy storage device 315 includes all components of the energy storage device, with the cooling air ducts, inlets and outlets removed. The inner casing 320 forms an air-tight seal around the inner core 322 of the energy storage device 315, and may be a heavy-duty box, for example. All of the inner core 322 components of the energy storage device, including the internal electronics of the energy storage device 315, are sealed within the inner casing 320. The system 310 further illustratively includes an outer layer 324 configured to surround the inner casing 320. The outer layer 324 may be an insulative layer made from an insulation material, such as WDS, for example. A pair of mounting brackets 323 pass through the outer layer 324, and are coupled to the inner casing 320 adjacent to opposing end surfaces 333,334 of the inner core, to spatially suspend the inner casing 320 within the outer layer 324. FIG. 5 illustrates an inner casing 320 configured to encapsulate two inner cores 322 of two energy storage devices 315, and the outer layer 324 configured to surround the inner casing 320.

In between the outer layer 324 and the inner casing 320 is an inner space 326 which is configured to receive cooling fluid 328 through an inlet 318 in the outer layer 324. As illustrated in the end-view of FIG. 4, the inner space 326 surrounds the inner casing 320, which is attributed to the spacing of the outer layer 324 around the inner casing 320, although the outer layer 324 may have varying spacing from the inner casing 320. Additionally, FIG. 4 illustrates an outlet 336 in the outer layer 324, which is positioned adjacent to the inlet 318, however the outlet 336 may be positioned at a location along the outer layer 324. Although FIG. 4 illustrates one inlet and one outlet in the outer layer, more than one inlet and/or outlet may be positioned within the outer layer 324.

As illustrated in FIG. 4, the inner casing 320 is a rectangular-shaped casing with six external surfaces 329,330,331,332,333,334, including four side surfaces 329,330,331,332 and two end surfaces 333,334. Although the inner casing illustrated in FIG. 4 is a rectangular-shaped casing, the inner casing may take any shape, provided that outside air remains sealed off from entering the interior of the inner core during convection of the outside air along the external surfaces of the inner casing 320.

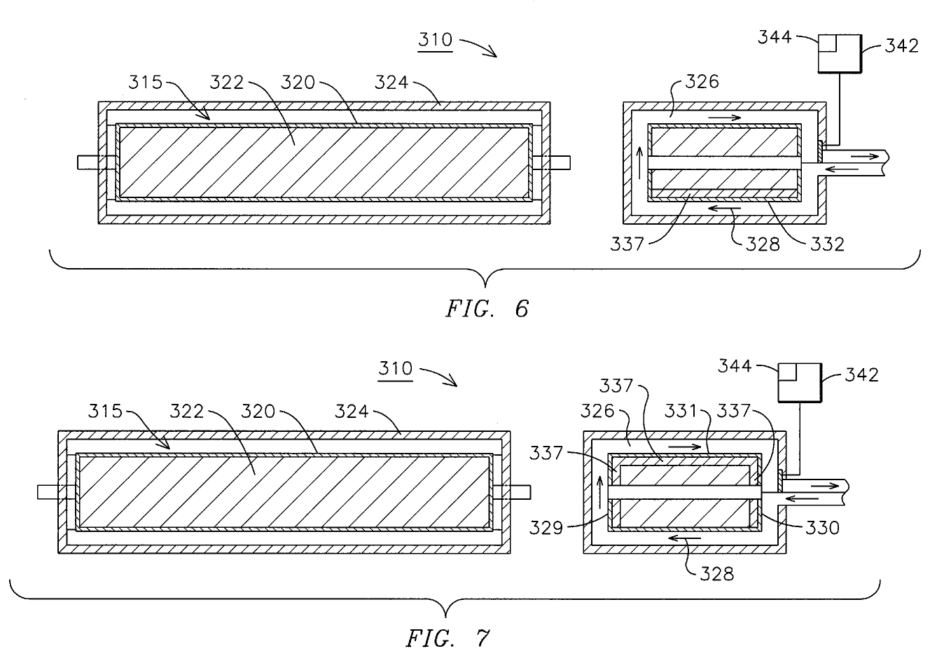

As illustrated in the exemplary embodiment of FIG. 6, the inner casing 320 further includes an inner insulative layer 337 along a bottom external surface 332 of the inner casing. The inner insulative layer 337 is configured to control convection of the cooling fluid 328 along the bottom external surface 332 within the inner space 326. In the exemplary embodiment of FIG. 6, the bottom external surface 332 may be in more intimate contact with the inner cells of the energy storage device proximate to the bottom external surface 332, and thus the heat transfer properties of the bottom external surface 332 may be greater than the other external surfaces, resulting in an imbalance of convection of the bottom external surface with outside air within the inner space 326, as compared to the other external surfaces. Accordingly, by positioning the inner insulative layer 337 along the bottom external surface 332, the convection of outside air along each external surface of the inner casing 320 may be balanced out. As illustrated in the additional exemplary embodiment of FIG. 7, inner insulative layers 337 may be positioned along three (i.e., more than one) external surfaces 329,330,331 of the inner casing 320, also to balance the convection of cooling fluid 328 within the inner space 326 among the external surfaces. Although FIGS. 6 and 7 illustrate inner insulative layers 337 of constant thickness between external surfaces and along each external surface, the inner insulative layer may have a varying thickness among external surfaces and/or a varying thickness along a single external surface, in order to stabilize the respective convection of cooling fluid along each respective external surface.

As illustrated in FIG. 4, a controllable outlet 341 is positioned within the outer layer 324. The controllable outlet 341 illustratively is a movable gate and is configured to selectively open and close the outlet 336 to control a flow of cooling fluid 328 within the inner space 326. Although FIGS. 4, 6-7 illustrate a movable gate, the controllable outlet may take several different forms which selectively open and close the outlet. Additionally, a controller 342 is coupled to the controllable outlet 341 and includes a stored maximum temperature threshold and minimum temperature threshold in a memory 344. The maximum and minimum temperature threshold are the maximum and minimum temperature thresholds represent the maximum and minimum temperatures for which the cooling system respectively turns on and off. However, the system does not require any such maximum and minimum temperature thresholds. The controller 342 is configured to monitor the temperature of the inner core 322. The controller 342 is configured to close the controllable outlet 341 (i.e., close the movable gate) to cease the flow of cooling fluid 328 within the inner space 326 upon determining that the temperature of the inner core 322 is less than the minimum temperature threshold stored in the memory 344. In the event that the controller 342 closes the controllable outlet 341 and shuts off the flow of cooling fluid 328, the outer insulative layer 324 serves to insulate the cooling fluid 328 within the inner space 326, and thus stabilizes the temperature of the cooling fluid 328 and the inner core 322 of the energy storage device 315 to achieve a thermal equilibrium. If the outer insulative layer 324 did not stabilize the temperature of the cooling fluid 328 with the temperature of the inner core 322, the inner core 322 would constantly lose heat energy from constantly heating up the cooling fluid 328, and would eventually require an unintended heating cycle. The controller 342 is configured to open the controllable outlet 341, and initiate a flow of cooling fluid 328 within the inner space 326, upon the controller 342 determining that the temperature of the inner core 322 is greater than the maximum temperature threshold stored in the memory 344. In an exemplary embodiment, the controllable inlet 318 and controllable outlet 341 may be a movable gate which may selectively open and closed by the controller 342 to control the flow of cooling fluid 328 into the inner space 326, for example. Upon the controller 342 initiating a flow of cooling fluid 328 within the inner space 326, each external surface 329,330,331,332,333,334 of the inner casing 320 is configured to engage in convection with the cooling fluid 328 received through the inlet 318. In an exemplary embodiment of the system 310, the flow of cooling fluid 328 into the inlet 318 is based upon the motion of the locomotive, and thus the cooling fluid 328 enters the inner space 326 when the inlet 318 is open and the locomotive is in motion. A scoop device (not shown) may be attached external to the inlet 318 to assist in directed outside air into the inner space 326 during motion of the locomotive. However, the flow of cooling fluid 328 may be independent of the motion of the locomotive, and instead be assisted by a blower powered by a motor and positioned adjacent to the each inlet, for example.

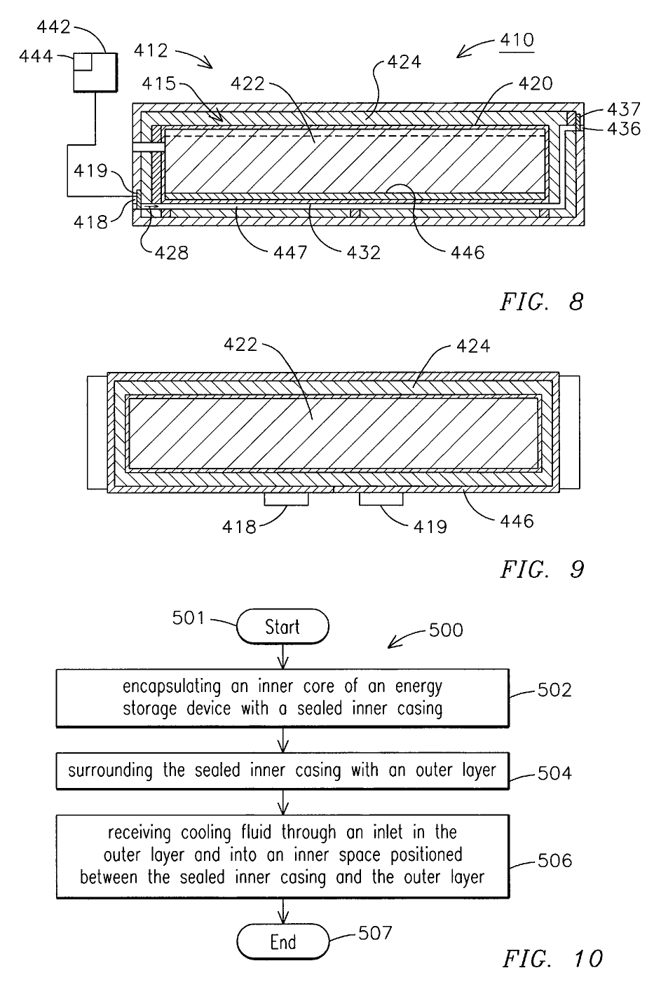

FIG. 8 illustrates an additional embodiment of a system 410 for cooling an energy storage system 412 of a hybrid diesel electric locomotive. The energy storage system 412 includes one or more energy storage devices 415. Although FIG. 8 illustrates one energy storage device 415, the system 410 may be utilized with a plurality of energy storage devices 415. The system 410 illustratively includes an inner casing 420 configured to encapsulate an inner core 422 of an energy storage device 415 of the energy storage system 412. The inner core 422 of the energy storage device 415 includes all components of the energy storage device, with the cooling air ducts, inlets and outlets removed. The inner casing 420 forms an air-tight seal around the inner core 422 of the energy storage device 415. All of the inner core 422 components of the energy storage device, including internal electronics, are sealed within the inner casing 420.

Additionally, the system 410 includes a heat transfer surface 446 configured to thermally engage the bottom external surface 432 of the inner casing 420. The heat transfer surface 446 is illustratively positioned within the inner casing 420 and adjacent to the bottom external surface 432. The heat transfer surface 446 is configured to extract heat energy from within the inner core 422 to the heat transfer surface 446, for subsequent transfer of the extracted heat energy to cooling fluid during convection (discussed below). Although FIG. 8 illustrates the heat transfer surface 446 positioned within the inner casing 420 and along the bottom external surface 432 of the inner casing 420, the heat transfer surface may be positioned external to the inner casing and along the bottom external surface of the inner casing 420. Additionally, although FIG. 8 illustrates the heat transfer surface positioned along the bottom external surface of the inner casing, the heat transfer surface may be positioned along any external surface of the inner casing, or more than one external surface of the inner casing, provided that certain parameters are met related to the positioning of the inlet and the outlet of the cooling system, as described below. The heat transfer surface 446 may be one of a conducting material and a heat sink material, for example, or any material capable of extracting heat energy from the interior of the inner core for subsequent convection with cooling fluid, as described below. Additionally, a heat transfer liquid may be utilized in place of the heat transfer surface 446 within the inner casing 420 and within the inner core 422, to promote heat transfer to an external surface, such as the bottom external surface 432, for example. In addition to providing the heat transfer surface 446, the thermal storage capacity within the inner core 422 may be evenly distributed by providing additional mass and/or phase change material(s) within the inner core 422, for example.

As further illustrated in FIG. 8, an outer layer 424 is configured to surround each inner casing 420. The outer layer 424 may be an insulative layer made from an insulation material, such as WDS and/or VAC, for example. An inlet 418 is illustratively positioned within the outer layer 424 and is configured to receive cooling fluid 428 within a cooling duct 447. The cooling duct 447 is configured to facilitate convection of the cooling fluid 428 with the heat transfer surface 446 adjacent to the bottom external surface 432. Since the heat transfer surface 446 has extracted the heat energy from within the inner core 422, the heat transfer surface heats up while the interior of the inner core 422 cools down. The cooling fluid 428 thermally engages the heat transfer surface 446 during motion of the locomotive, as the motion of the locomotive forces the cooling fluid into the inlet 418. Subsequent to the cooling fluid 428 undergoing convection with the heat transfer surface 446, the cooling fluid 428 passes through an outlet 436 positioned above the inlet 418. Since the outlet 436 is positioned above the inlet 418, the natural convection (i.e., chimney effect) of the cooling fluid 428 is facilitated. Accordingly, if the heat transfer surface 446 was repositioned to an alternate external surface of the inner casing 420, the outlet may need to be repositioned, based on the repositioning of the cooling duct and the inlet, to ensure that the height difference of the outlet above the inlet is maintained. Although FIG. 8 illustrates one inlet and one outlet within the outer layer 424, more than one inlet, outlet and cooling duct may be utilized.

FIG. 8 illustrates a controllable inlet 419 positioned in the outer layer 424 and configured to selectively open and close the inlet 418 to control a flow of cooling fluid 428 within the cooling duct 447. A controller 442 is illustratively coupled to the controllable inlet 419 with a stored minimum and maximum temperature threshold in a memory 444. The maximum and minimum temperature threshold are the maximum and minimum temperature thresholds represent the maximum and minimum temperatures for which the cooling system respectively turns on and off. However, the system 410 does not require any such maximum and minimum temperature thresholds to operate. The controller 442 is configured to monitor a temperature of the inner core 422. FIG. 8 further illustrates a controllable outlet 437 in the outer layer 424 positioned above the controllable inlet 419 and configured to selectively open and close with the controllable inlet 419. In an exemplary embodiment, the controllable inlet and controllable outlet may be a movable gate which may be selectively open and closed by the controller to control the flow of cooling fluid into the inner space, for example, but other mechanisms to selectively open and close the respective inlets and outlets may be utilized. The controller 442 is configured to close the inlet 418, and cease the flow of cooling fluid 428 within the cooling duct 447 upon the controller 442 determining that the inner core 422 temperature is less than the minimum temperature threshold.

In the event that the controller ceases the flow of cooling fluid 428 within the cooling duct 447, the outer insulative layer 424 is configured to insulate the cooling fluid 428 with the cooling duct 447 and thus stabilize the temperature of the cooling fluid 428 and the inner core 422 of the energy storage device 415 to achieve a thermal equilibrium. The controller 442 is configured to open the inlet 418, and initiate a flow of cooling fluid 428 within the cooling duct 447 upon the controller 442 determining that the inner core 422 temperature is greater than the maximum temperature threshold.

In addition to circulating the cooling fluid 428 within the cooling duct, in an exemplary embodiment, an internal cooling medium may be circulated within the internal core 422 to stabilize an internal temperature of the internal core 422. For example, the internal core includes a plurality of cells with at least one air gap between respective cells, and each air gap may result in a respective internal temperature imbalance within the internal core. The internal cooling medium may be configured to conduct heat energy between the air gaps to reduce the occurrences of the air gaps and stabilize the internal temperature.

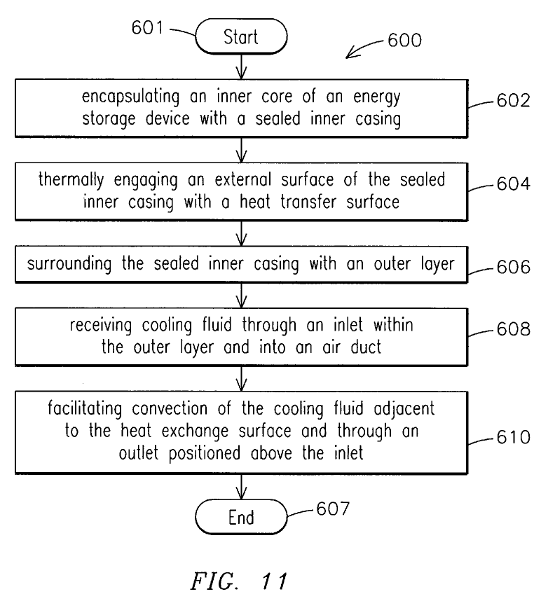

FIG. 10 illustrates an exemplary embodiment of a method 500 for cooling an energy storage system 312 of a hybrid diesel electric vehicle, where the energy storage system 312 includes one or more energy storage devices 315. The method 500 begins (block 501) by encapsulating (block 502) an inner core 322 of an energy storage device 315 with an inner casing 320, followed by surrounding (block 504) the inner casing 320 with an outer layer 324. The method further includes receiving (block 506) cooling fluid through an inlet 318 in the outer layer 324 and into an inner space 326 positioned between the inner casing 320 and the outer layer 324.

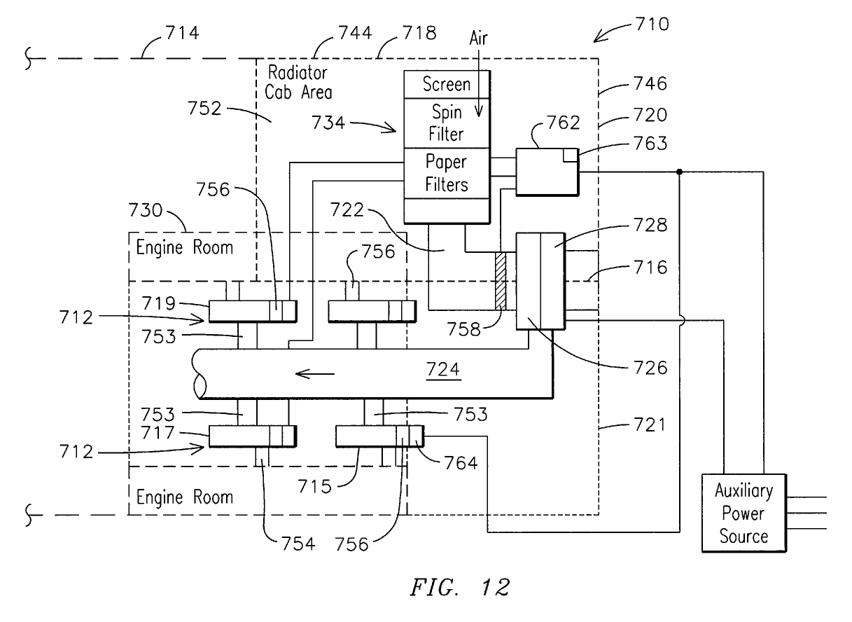

FIG. 11 illustrates an exemplary embodiment of a method 600 for cooling an energy storage system 412 of a hybrid diesel electric vehicle, where the energy storage system 412 includes one or more energy storage devices 415. The method 600 begins (block 601) by encapsulating (block 602) an inner core 422 of an energy storage device 415 with an inner casing 420. The method 600 further includes thermally engaging (block 604) an external surface 432 of the inner casing 420 with a heat transfer surface 446. The method 600 further includes surrounding (block 606) the inner casing 420 with an outer layer 424, and receiving (block 608) cooling fluid 428 through an inlet 418 within the outer layer 424 and into an cooling duct 447. The method further includes facilitating convection (block 610) of the cooling fluid 428 adjacent to the heat transfer surface 446 and through an outlet 436 positioned above the inlet 418.

FIG. 12 illustrates an embodiment of a system 710 for cooling an energy storage system 712 of a hybrid diesel electric locomotive 714. The energy storage system 712 illustratively includes a plurality of energy storage devices 715, including a maximum temperature storage device 717 having a maximum temperature 721 and a minimum temperature storage device 719 having a minimum temperature 723 among the energy storage devices. Although FIG. 12 illustrates the energy storage devices 715 positioned below a locomotive platform 716, the energy storage devices 715 may be positioned on or above the locomotive platform 716. The exemplary embodiment of the system 710 illustrated in FIG. 12 further includes an air duct 724 in flow communication with an air inlet 718 and each energy storage device 715. The air inlet 718 is in the exemplary embodiment of FIG. 12 is positioned along the outer surface 720 of the locomotive 714 and above the locomotive platform 716, but may be positioned at any location along the outer surface, either above or below the locomotive platform 716. Additionally, the system 710 includes a blower 726 positioned within the air duct 724 to draw outside air into the air inlet 718 and through the air duct 724 to pass the outside air over or through each energy storage device 715. Those other elements of the system 710, illustrated in FIG. 12 and not discussed herein, are similar to those elements discussed above, with 700 notation, and require no further discussion herein.

Additionally, as illustrated in the exemplary embodiment of FIG. 12, the system 710 further includes a controller 762 coupled with each energy storage device 715. The controller 762 may be coupled to a respective temperature sensor 764 of each energy storage device 715. The controller 762 is configured to increase the temperature of each energy storage device 715 whose temperature is below the maximum temperature 721 reduced by a predetermined threshold stored in a memory 763 of the controller 762. For example, if the maximum temperature storage device 717 has a maximum temperature 721 of 300 degrees Celsius, and the stored predetermined threshold in the memory 763 of the controller 762 is 15 degrees Celsius, the controller 762 proceeds to increase the temperature of each energy storage device 715 having a temperature less than 285 degrees Celsius, using one a variety of heat sources, as described below. However, the exemplary embodiment of a maximum temperature storage device 717 with a maximum temperature of 300 degrees Celsius is merely an example and the maximum temperature storage device 717 may have any maximum temperature 721 value. The controller 762 illustrated in the exemplary embodiment of FIG. 12 is configured to monitor the temperature of each energy storage device 715, such that the controller activates the blower 726 when the temperature of an energy storage device 715 exceeds the maximum temperature threshold. Additionally, the controller deactivates the blower 726 when the temperature of an energy storage device 715 falls below the minimum temperature threshold.

Although FIG. 12 illustrates one air duct communicatively coupled to one air inlet, one blower positioned within the air duct, and one controller coupled to each energy storage device, more than one air duct may be communicatively coupled to a respective inlet, more than one blower may be respectively positioned within each air duct, and more than one controller may be coupled to each energy storage device.

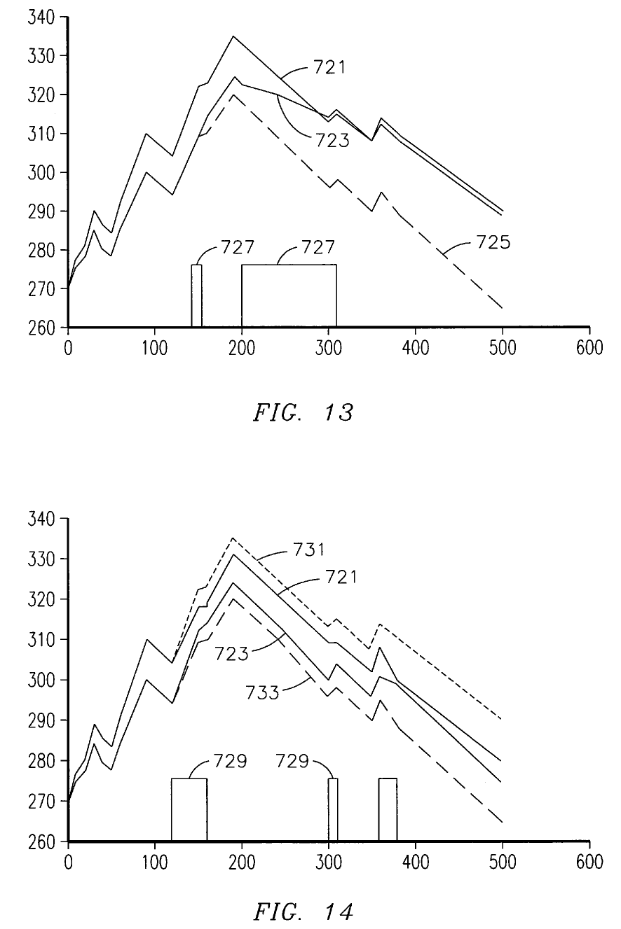

FIG. 13 illustrates an exemplary timing diagram of the maximum temperature 721 and minimum temperature 723 of the respective maximum temperature storage device 717 and minimum temperature storage device 719 of the energy storage system 712. As illustrated in the exemplary timing diagram of FIG. 13, at approximately t=150, the controller 762 proceeds to increase the temperature of the minimum storage device 719, as indicated by the on/off heating waveform 727 of the controller, representative of a signal from the controller 762 to a heat device 756 of the minimum temperature storage device 719, to heat the minimum temperature storage device, as discussed below. In the exemplary embodiment of FIG. 13, the controller 762 is configured to increase the temperature of the minimum temperature storage device 719 having the minimum temperature 723, since the minimum temperature 723 at t=150 is less than the maximum temperature 721 reduced by a predetermined threshold stored in the memory 763, such as 10 degrees, for example. The controller 762 is configured to increase the temperature of the minimum temperature storage device 719 (and any energy storage device 715 which meets the proper criteria) to within a predetermined range, such as 5 degrees Celsius, for example, of the maximum temperature 721. In the exemplary embodiment of FIG. 13, the controller 762 increases the temperature of the minimum temperature storage device 719 periodically until approximately t=310, when the minimum temperature 723 is within a predetermined range, such as 5 degrees Celsius, for example, of the maximum temperature 721. The controller 762 may manually increase the temperature of each energy storage device 715 which meets the above criteria, based on manually assessing the temperature difference between the temperature of each energy storage device and the maximum temperature 721 with the temperature threshold at each time increment. As illustrated in FIG. 13, if the controller 762 were not to increase the temperature of the minimum temperature storage device 719, the minimum temperature 723 curve would instead have taken the alternative minimum temperature 725 curve illustrated in FIG. 13, and the operating range of the energy storage system, measured by the temperature difference between the maximum temperature 721 and the minimum temperature 725 would be noticeably greater than the reduced operating range of the temperature difference between the maximum temperature 721 and the minimum temperature 723. In the exemplary timing diagram of FIG. 13, the time rate of change of the maximum temperature 721 and minimum temperature 723 is dependent on the blower speed 726, an energy load on each energy storage device 715 and an ambient temperature of each energy storage device 715.

As discussed above, when the controller 762 increases the temperature of an energy storage device, the controller 762 is configured to activate a heat device 756, such as a heating circuit, for example, of each energy storage device 715. The controller 762 supplies heat energy from the traction motors of the locomotive 714 to each heat device 756 during a dynamic braking mode of the locomotive. However, in an exemplary embodiment, the controller 762 may be configured to activate the heat device 756, such as a heating circuit, for example, of each energy storage device 715, with heat energy supplied from a locomotive engine during a motoring mode or idle mode of the locomotive, for example.

Within the memory 763 of the controller 762, the identity of particular energy storage devices 715 having a history of consistently lower temperatures relative to the other energy storage devices may be stored. During operation of the system 710, the controller 762 may be configured to increase the temperature of those previously identified energy storage devices 715 stored in the memory 763 with a previous history of low temperature, from below the maximum temperature 721 reduced by the predetermined threshold to greater than the maximum temperature 721 increased by a predetermined range. Thus, the controller 762 is configured to overcorrect for those energy storage devices 715 having a previous history of lower temperature by heating those energy storage devices 715 beyond the maximum temperature 721 in anticipation that their temperature will fall lower than expected. The controller 762 is configured to increase the temperature of the energy storage devices 715 identified with a previous history of low temperature during a dynamic braking mode with heat energy supplied from the traction motors, but may increase their temperature during a motoring mode or idle mode with heat energy supplied from the locomotive engine.

The controller 762 is configured to preheat the temperature of each energy storage device 715 with a temperature lower than the maximum temperature 721 reduced by the predetermined threshold to within a predetermined range of the maximum temperature. For example, the controller 762 may preheat the temperature of an energy storage device 715 from a temperature of 280 degrees Celsius, lower than the maximum temperature of 330 degrees Celsius reduced by a predetermined threshold of 10 degrees Celsius, to 325 degrees Celsius, or to within a predetermined range of 5 degrees of the maximum temperature of 330 degrees. The controller 762 is configured to preheat each energy storage device 715 during a dynamic braking mode and prior to the termination of a dynamic braking mode of the locomotive.

In addition to preheating an energy storage device, as discussed above, the controller 762 may be additionally configured to precool the temperature of each energy storage device 715 from a temperature above the minimum temperature 723 raised by the predetermined threshold to within a predetermined range of the minimum temperature. For example, the controller 762 may precool an energy storage device from a temperature of 320 degrees Celsius, since this temperature is above a minimum temperature of 270 degrees Celsius raised by a predetermined threshold of 10 degrees Celsius, and the controller 762 may precool the energy storage device to 275 degrees Celsius, or to within a predetermined range of 5 degrees Celsius of the minimum temperature of 270 degrees Celsius. The controller 762 may be configured to precool each energy storage device 715 prior to an encountering an upcoming anticipated dynamic braking mode, since an upcoming opportunity to heat the energy storage devices is imminent.

Each energy storage device 715 has a state of charge, and the controller 762 is configured to preheat the temperature of each energy storage device 715. The preheating may be based on state of charge. The description above is based on previous history, it is also possible to obtain a transfer function of the heat dissipation/temperature excursion based on the state of charge of the storage device (for example high SOC devices tend to transfer heat faster, while low SOC devices may be heated to compensate for the differing temperature). Another option is that the optimum operating temperature of each energy storage device is a function of the SOC. Accordingly, the difference in the SOC may be adjusted instead of the temperature difference between the maximum temperature storage device and minimum temperature storage.

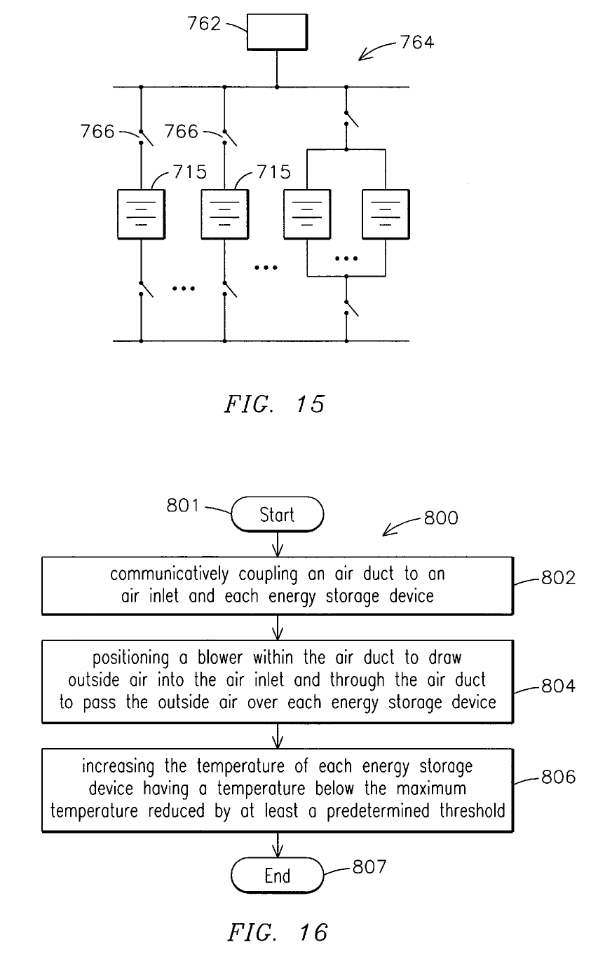

FIG. 14 illustrates an additional embodiment of the system 710, in which the controller 762 is configured to disconnect each energy storage device 715 from the energy storage system 712 having a temperature above the maximum temperature 721 lowered by the predetermined threshold. Upon disconnecting each of the energy storage devices 715 which meet the above criteria, the controller 762 is configured to increase the temperature of each energy storage device 715 with a temperature lower than the maximum temperature 721 reduced by the predetermined threshold. In an exemplary embodiment, if the maximum temperature is 300 degrees Celsius, the minimum temperature is 270 degrees Celsius, and the predetermined threshold is 10 degrees Celsius, the controller 762 is configured to disconnect each energy storage device 715 with a temperature above 290 degrees Celsius and is further configured to increase the temperature of each energy storage device 715 with a temperature lower than 290 degrees Celsius. In an additional exemplary embodiment, the controller may be configured to disconnect the maximum temperature storage device 717 and increase the temperature of the minimum temperature storage device 719. The controller 762 is configured to disconnect each energy storage device 715 with the previously discussed criteria and increase each energy storage device 715 with the previously discussed criteria during a low power demand on each energy storage device. The low power demand on each energy storage device 715 may take place during a dynamic or brake propulsion mode of the locomotive 714 For example, if the locomotive 714 demands 400 HP in secondary energy from 40 energy storage devices, thus amounting to 10 HP per energy storage device, if the controller 762 disconnects 20 energy storage devices with the hottest temperatures, the remaining 20 energy storages devices will necessarily take on twice their previous load, or 20 HP each, thereby increasing their respective temperature. Accordingly, the controller 762 is configured to increase the temperature of each energy storage device 715 meeting the above criteria by increasing the power demand on each energy storage device 715. However, the controller 762 may increase the temperature of the energy storage devices from the energy storage system using methods other than increasing the respective loads of each energy storage device. During a dynamic braking mode, the heat energy may be supplied from the traction motors, which is then supplied to the respective heating devices 756 of each energy storage device 715. Alternatively, the low power demand on each energy storage device 715 may take place during a motoring mode or idle mode, in which case the heat energy supplied to each respective heating device 756 may come from the locomotive engine.

As illustrated in the exemplary timing diagram of FIG. 14, the controller 762 disconnects the maximum temperature storage device 717 from the energy storage system 712 at approximately t=100, since the maximum energy 721 exceeds the maximum energy reduced by the predetermined threshold. At the same time, the controller 762 begins to increase the temperature of the minimum temperature storage device 719, since the minimum temperature 723 is lower than the maximum temperature 721 reduced by the predetermined threshold (e.g., 10 degrees Celsius). Although the maximum temperature storage device 717 is disconnected from the energy storage system 712, the maximum temperature 721 remains tracked by the controller 762 and plotted in FIG. 14. The activation of the heating device 756 within the minimum temperature storage device 719 is depicted by the waveform 729 at approximately t=120, 300 and 360. As illustrated in the exemplary embodiment of FIG. 14, the controller 762, is configured to minimize the difference between the maximum temperature 721 and the minimum temperature 723 over time for the respective maximum temperature storage device 717 and the minimum storage device 719. This minimization is depicted when comparing the maximum temperature 721 and minimum temperature 723 curves after the controller 762 disconnected the maximum temperature storage device 717 and increased the temperature of the minimum temperature storage device 719, with the minimum temperature 733 curve and maximum temperature 731 curve which would result if the controller 762 did not disconnect or heat the respective maximum temperature storage device 717 and minimum temperature storage device 719. As shown in FIG. 14, the operating range of the energy storage system 712, measured by the temperature difference between the maximum energy 721 and the minimum energy 723 is noticeably reduced after the controller 762 disconnected the maximum temperature storage device 717 and increased the temperature of the minimum temperature storage device 719. Although FIG. 14 depicts the controller 762 having disconnected and increased the energy of a single maximum energy device 717 and minimum energy device 719, the controller may disconnect multiple energy devices and increase the temperature of multiple energy devices, so to narrow the operating temperature range of the energy storage system. Accordingly, the exemplary diagram of FIG. 14 includes exemplary values and ranges, and the embodiments of the present invention are not limited to any exemplary values or ranges shown in FIG. 14, or any other exemplary diagram of the present application.

As illustrated in the exemplary embodiment of FIG. 15, the controller 762 is configured to disconnect one or more energy storage devices 715. The controller may be coupled to a parallel bus circuit 764, where each parallel bus circuit includes one or more switches 766 configured to selectively connect each energy storage device 715 in a parallel arrangement within each parallel bus circuit 764. The controller 762 is configured to selectively switch on and off each switch 766 to respectively connect and disconnect each energy storage device 715 from the energy storage system 712, as disclosed previously.

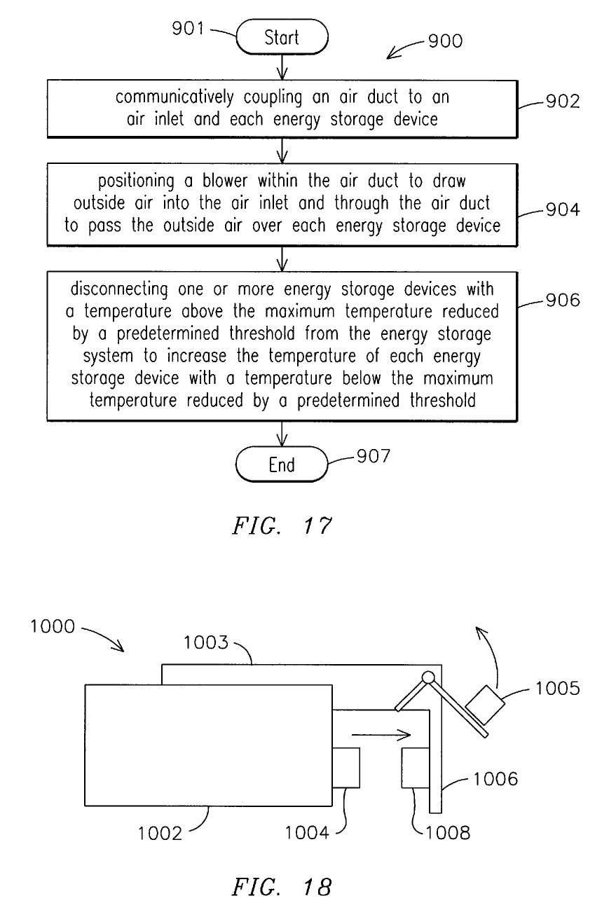

FIG. 16 illustrates an exemplary embodiment of a method 800 for cooling an energy storage system 712 of a hybrid diesel electric locomotive 714. The energy storage system 712 includes a plurality of energy storage devices 715, including a maximum temperature storage device 717 having a maximum temperature 721 and a minimum temperature storage device 719 having a minimum temperature 723. The method 800 begins (block 801) by communicatively coupling (block 802) an air duct 724 to an air inlet 718 and each energy storage device 715. The method 800 further includes positioning (block 804) a blower 726 within the air duct 724 to draw outside air into the air inlet 718 and through the air duct 724 to pass the outside air over or through each energy storage device 715. The method further includes increasing (block 806) the temperature of each energy storage device 715 having a temperature below the maximum temperature 721 reduced by at least a predetermined threshold, before ending at block 807.

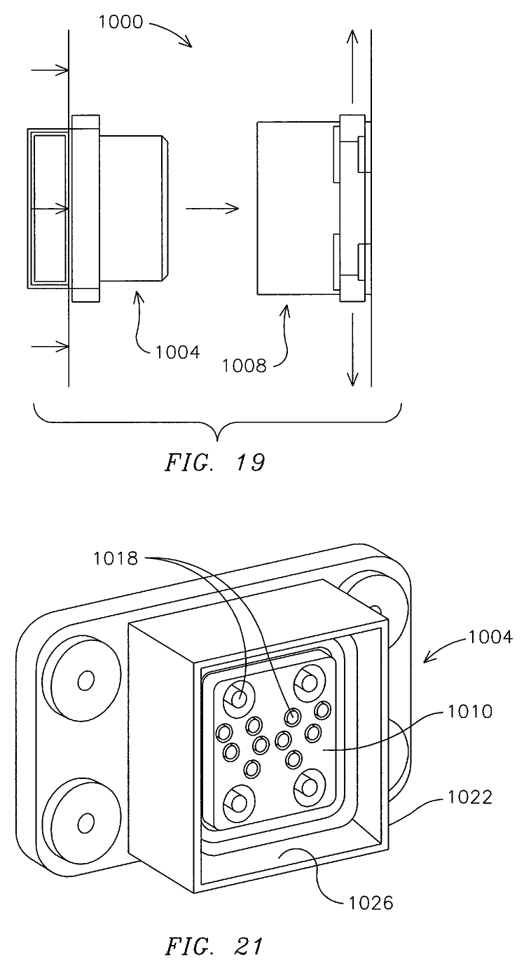

FIG. 17 illustrates an exemplary embodiment of a method 900 for cooling an energy storage system 712 of a hybrid diesel electric locomotive 714. The energy storage system 712 includes a plurality of energy storage devices 715, including a maximum temperature storage device 717 having a maximum temperature 721 and a minimum temperature storage device 719 having a minimum temperature 723. The method 900 begins (block 901) by communicatively coupling (block 902) an air duct 724 to an air inlet 718 and each energy storage device 715. The method 900 subsequently involves positioning (block 904) at least one blower 926 within the air duct 924 to draw outside air into the air inlet 718 and through the air duct 924 to pass the outside air over or through each energy storage device 715. The method further includes disconnecting (block 906) one or more energy storage devices 715 with a temperature above the maximum temperature 721 reduced by a predetermined threshold from the energy storage system 712 to increase the temperature of each energy storage device 715 with a temperature below the maximum temperature 721 reduced by a predetermined threshold, before ending at block 907.

Based on the foregoing specification, the above-discussed embodiments of the invention may be implemented using computer programming or engineering techniques including computer software, firmware, hardware or any combination or subset thereof, wherein the technical effect is to cool each energy storage device of a hybrid diesel electric vehicle. Any such resulting program, having computer-readable code means, may be embodied or provided within one or more computer-readable media, thereby making a computer program product, i.e., an article of manufacture, according to the discussed embodiments of the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware, such as a microprocessor, to create a computer system or computer sub-system of the method embodiment of the invention. An apparatus for making, using or selling embodiments of the invention may be one or more processing systems including, but not limited to, a central processing unit (CPU), memory, storage devices, communication links and devices, servers, I/O devices, or any sub-components of one or more processing systems, including software, firmware, hardware or any combination or subset thereof, which embody those discussed embodiments the invention.

FIGS. 18-22 illustrate one embodiment of a system 1000 for connecting a battery 1002 to a mounting system 1006, such as a hybrid energy vehicle, for example. One example of such a hybrid energy vehicle may be a hybrid energy locomotive. The battery 1002 is illustratively coupled to a battery connector 1004. Similarly, the hybrid energy locomotive 1006 is coupled to a hybrid energy locomotive connector 1008. The battery 1002 may be supported and moved toward the hybrid energy locomotive 1006 along a rail (not shown) within a support member 1003, and the support member may extend to the hybrid energy locomotive 1006, as illustrated in FIG. 18. However, the battery 1002 may be supported and moved toward the hybrid energy locomotive using any of a number of methods appreciated by one of skill in the art. Additionally, as illustrated in the exemplary embodiment of FIG. 18, upon connecting the battery connector 1004 with the hybrid energy locomotive connector 1008 and establishing a successful electrical connection, an indication flag 1005 rotates upward to indicate the successful electrical connection. However, any such indication device other than the illustrated indication flag may be utilized to demonstrate to the operator moving the battery toward the hybrid energy locomotive that a successful electrical connection has been established.

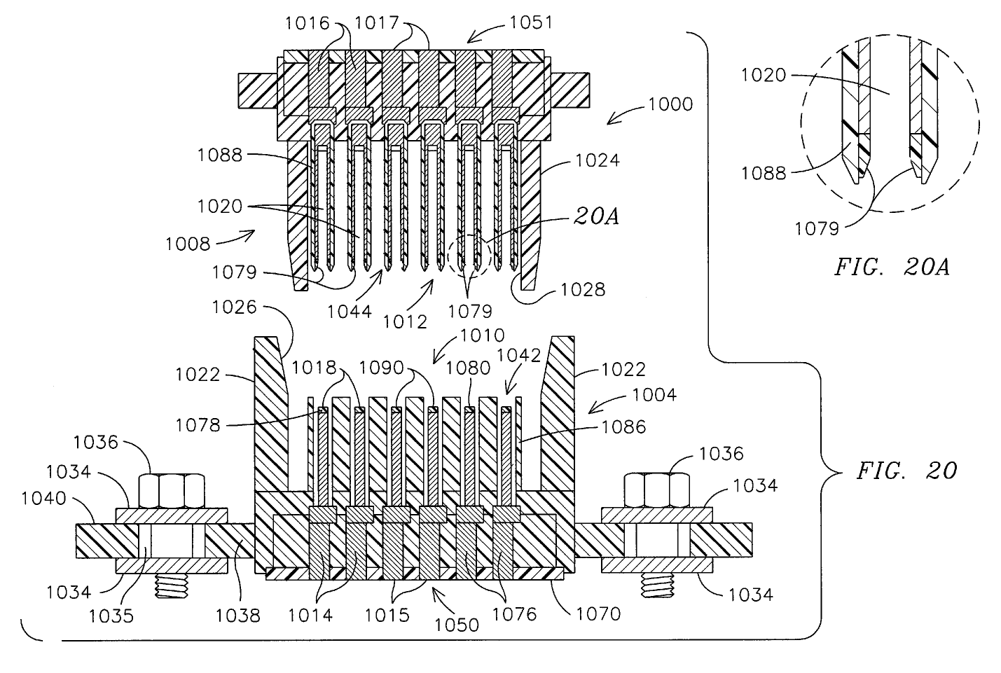

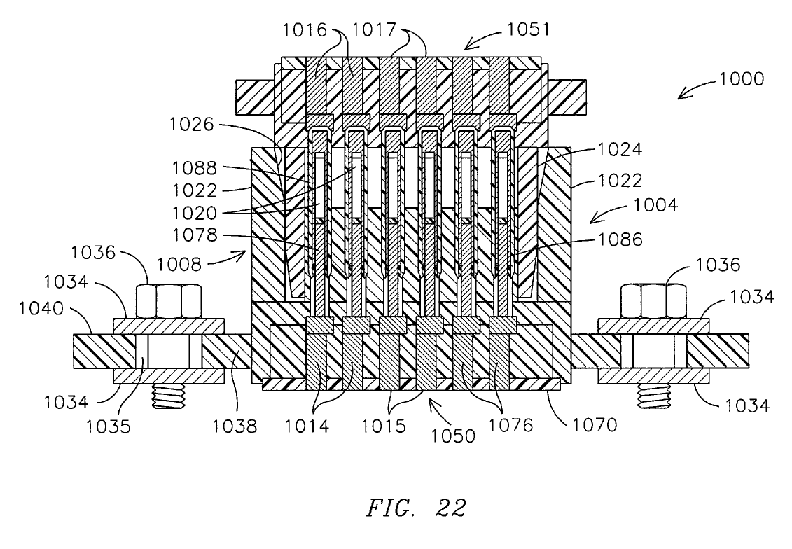

As illustrated in the exemplary embodiments of FIGS. 20, 20A, and 21, the battery connector 1004 further includes an inner housing 1010 which is configured to receive a plurality of cables 1014 from the battery 1002 through a plurality of respective openings 1015 in a back end 1050 of the inner housing 1010. A respective plurality of male connectors 1018 are positioned within a plurality of slots 1090 of the inner housing 1010 of the battery connector 1004, where each male connector 1018 is coupled to a respective cable 1014 adjacent to the back end 1050 of the inner housing 1010. The battery connector 1004 further includes an outer housing 1022 to surround the inner housing 1010, where the outer housing 1022 includes a tapered wall 1026.

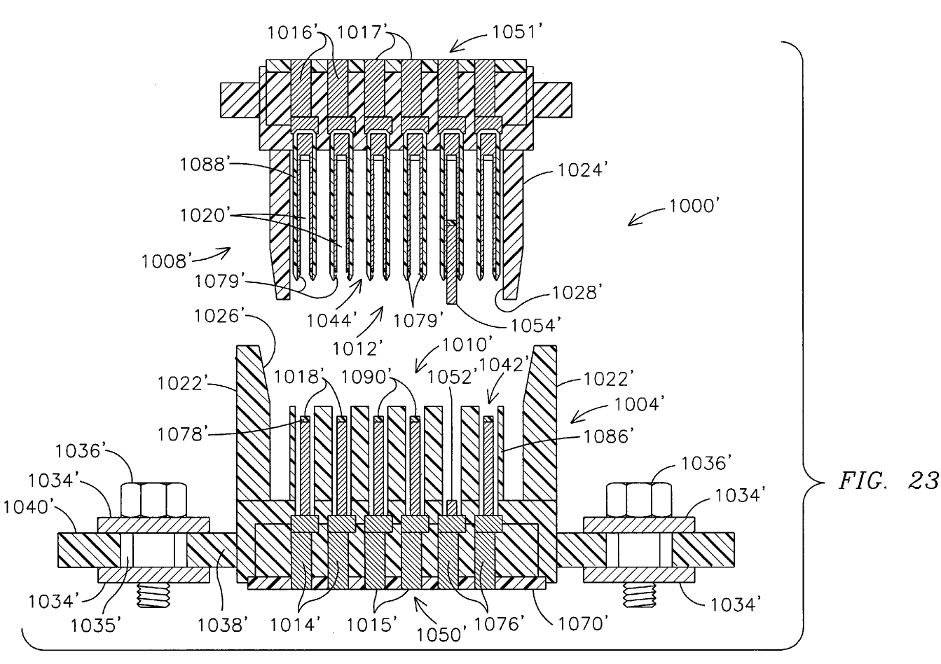

As similarly illustrated in the exemplary embodiment of FIGS. 20 and 20A, the hybrid energy locomotive connector 1008 includes an inner housing 1012 configured to receive a plurality of cables 1016 from the hybrid energy locomotive 1006 through a plurality of respective openings 1017 in a back end 1051 of the inner housing 1012. A respective plurality of female receptacles 1020 are positioned within the inner housing 1012 of the hybrid energy locomotive connector 1008, where each female receptacle 1020 is coupled to a respective cable 1016 adjacent to the back end 1051 of the inner housing 1012. The respective plurality of male connectors 1018 of the battery connector inner housing 1010 and the female receptacles 1020 of the hybrid energy locomotive inner housing 1012 are both configured to connect within the inner housing of the battery connector, as shown in FIG. 22. The hybrid energy locomotive connector 1008 further includes an outer housing 1024 to surround the inner housing 1012, where the outer housing 1024 includes a tapered wall 1028. In an exemplary embodiment of the present invention, the inner housings 1010, 1012 and outer housings 1022,1024 of the battery connector 1004 and the hybrid energy locomotive connector 1008 are made from a non-conductive material.

Subsequent to connecting the battery connector 1004 and the hybrid energy locomotive connector 1008, some failure condition may take place, such as a high current above a high threshold passing between the battery connector 1004 and the hybrid energy locomotive connector 1008, for example. Upon disconnecting the battery connector 1004 from the hybrid energy locomotive connector 1008 subsequent to such a failure condition, the plurality of cables 1014 and plurality of male connectors 1018 are configured to remain unexposed. Although FIG. 20 illustrates a plurality of male connectors and female receptacles respectively positioned within the plurality of slots of the inner housing of the battery connector and the hybrid energy locomotive, a plurality of female receptacles and male connectors may be respectively positioned within the plurality of slots of the inner housing of the battery connector and the hybrid energy locomotive.

To connect the battery connector 1004 to the hybrid energy locomotive connector 1008, the battery connector 1004 is moved toward the hybrid energy locomotive connector 1008, while the plurality of male connectors 1018 of the battery connector 1004 and the plurality of female receptacles 1020 of the hybrid energy locomotive connector 1008 are respectively aligned. To align the respective plurality of male connectors 1018 and plurality of female receptacles 1020, the tapered walls 1026,1028 of the respective battery connector 1004 and hybrid energy locomotive connector 1008 have a respective female and male tapered wall design. The female tapered wall 1026 of the battery connector 1004 has a tapered inner surface, while the male tapered wall 1028 of the hybrid energy locomotive connector 1008 has a tapered outer surface such that the tapered outer surface of the male tapered wall 1028 aligns with the tapered inner surface of the female tapered wall 1026, thereby self-aligning the battery connector 1004 and the hybrid energy locomotive connector 1008 when they are respectively brought together. In the illustrated exemplary embodiment of FIG. 20, the tapered outer surface of the male tapered wall 1028 is a flipped-mirror image (vertically and horizontally) of the tapered inner surface of the female tapered wall 1026, although it may be scaled to a different size. However, the tapered outer surface of the male tapered wall may have an outer tapered surface which generally aligns with the female tapered wall inner tapered surface, and need not necessarily take the form of a flipped mirror image (in both horizontal and vertical directions) of the female tapered wall. Additionally, the system 1000 may feature other structural features other than the male and female tapered walls to self-align the battery connector and hybrid energy locomotive connector.

In addition to utilizing the male and female tapered walls 1028,1026 of the outer housing of each battery connector 1004 and hybrid energy locomotive connector 1008 to self-align the connectors, the battery connector 1004 and hybrid energy locomotive connector 1008 further include a plurality of collars 1034 and a plurality of bolts 1036, where a portion 1038,1040 of the outer housing 1022 of the battery connector 1004 is positioned between the plurality of collars 1034. A bolt 1036 is passed through the plurality of collars 1034 and the portion 1038,1040 of the outer housing 1022 to restrict movement of the outer housing of the battery connector 1004 within the plane of the plurality of collars 1034 during the self-alignment of the battery connector 1004 and the hybrid energy locomotive connector 1008. Thus, the movement of the outer housing 1022 within the plane of the collars 1034 provides for self-alignment to account for variations in the axial and tilt dimensions when joining the battery connector 1004 and the hybrid energy locomotive connector 1008. In the illustrated exemplary embodiment of FIG. 20, the outer housing 1022 may move within a outer circular slot 1035 around the bolt 1036 passed through the collars 1034, where such motion of the outer housing 1022 is parallel to the collars 1034, for example.

In addition to the male and female tapered walls 1028,1026 and the motion of the outer housing 1022 within the plane of the collars 1034, additional structural features of the system 1000 are provided for self-alignment of the battery connector 1004 with the hybrid energy locomotive connector 1008. In the illustrated exemplary embodiment of FIG. 20, the inner housing 1010,1012 of the battery connector 1004 and the hybrid energy locomotive connector 1008 includes a plurality of tapered slots 1042,1044. The plurality of tapered slots 1042,1044 are respectively utilized to hold the respective plurality of male connectors 1018 and female receptacles 1020. Additionally, the tapered slots are configured to provide axial tolerance during the self-alignment of the battery connector 1004 and the hybrid energy locomotive connector 1008 subsequent to the self-alignment provided by the respective male and female tapered walls 1028,1026 of the outer housing and the movement of the outer housing 1022 along the plane of the collars 1034. As illustrated in the exemplary embodiment of FIG. 20, the tapered slots 1042,1044 include male convex slots 1044 to hold a plurality of female receptacles 1020, and female concave slots 1042 to hold a plurality of male connectors 1018. Although FIG. 20 illustrates a plurality of male convex slots within the inner housing of the hybrid energy locomotive connector and a plurality of female concave slots within the inner housing of the battery connector, the plurality of female concave slots may be positioned within the inner housing of the hybrid energy locomotive connector and the plurality of male convex slots may be positioned within the inner housing of the battery connector.

While connecting the battery connector 1004 and the hybrid energy locomotive connector 1008, the inner housing 1010,1012 of the battery connector 1004 and the hybrid energy locomotive connector 1008 is configured to move and self-align independent of the respective outer housing 1022,1024 of the battery connector 1004 and the hybrid energy locomotive connector 1008. The inner housing 1010,1012 and the outer housing 1022,1024 are respectively configured to self-align to overcome axial and tilt variations. However, the inner housing 1010 of the battery connector and hybrid energy locomotive connector may be configured to move and self-align with the respective outer housing of the battery connector and the hybrid energy locomotive connector.

As further illustrated in FIG. 20, a seal 1070 surrounds the plurality of openings 1015 adjacent the back end 1050 of the inner housing 1010 of the battery connector 1004 to receive the plurality of cables 1014 from the battery 1002. The seal 1070 is configured to form an interface between the battery connector 1004 and the battery 1002, and further to provide a sealed interface between the outer housing 1022 and the battery 1004. In the exemplary embodiment of FIG. 20, the seal 1070 is made from a non-conductive elastomer material, and is further configured to surround the openings 1015 adjacent to the back end 1050. The seal 1070 is further configured to protrude at each opening 1015 in a direction opposite from the back end 1050, where each protrusion 1076 is configured to receive a respective male connector 1018.

In addition to the seal 1070 provided at the back end 1050 of the inner housing 1010, a non-conductive cap 1078 covers an end 1080 of each male connector 1018 opposite to the back end 1050 of the inner housing 1010 (also a similar non-conductive covering 1079 covers an end of each female receptacle of the inner housing of the hybrid energy locomotive connector). The non-conductive cap 1078 and non-conductive covering 1079 may be made from a ceramic non-conductive material and may be respectively rigidly glued to the external surface of the male connector 1018 (or to the inner surface of a female receptacle 1020). Additionally, a non-conductive jacket 1086 surrounds the plurality of male connectors 1018 (and a corresponding jacket surrounds the plurality of female receptacles), where the jacket is positioned within a gap surrounding the plurality of male connectors 1018. In an exemplary embodiment, the non-conductive jacket may be a plastic jacket surrounding the plurality of male connectors (or female receptacles), and the respective male connectors and female receptacles of the battery connector and the hybrid energy locomotive connector are configured to connect at a middle portion beyond the non-conductive cap.

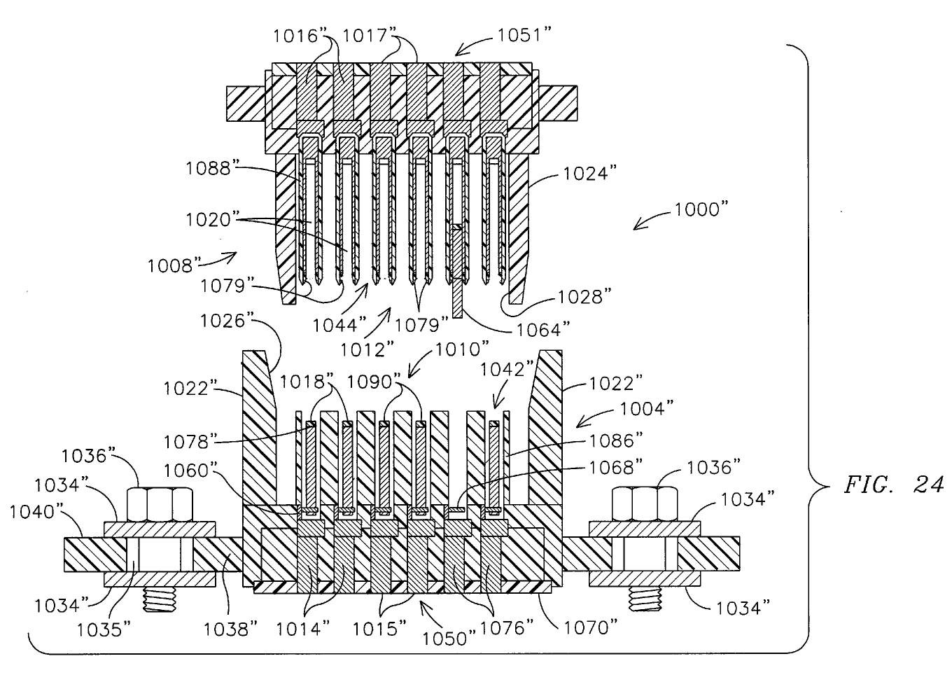

FIGS. 23,25 and 26 illustrate another exemplary embodiment of a system 1000′ including a battery connector 1004′. As illustrated in FIG. 23, the plurality of male connectors 1018′ each include a reduced diameter portion 1046′, where the reduced diameter portion 1046′ is configured to have a lower shear strength than an unreduced diameter portion 1048′ of each male connector 1018′. Although FIG. 23 illustrates a plurality of male connectors 1018′ within the inner housing 1010′ of the battery connector 1004′, a plurality of female receptacles may be similarly positioned within the inner housing, where each female receptacle would include a reduced diameter portion structure similar to the male connector illustrated in FIG. 23. The male connectors 1018′ of the exemplary embodiment of the system 1000′ illustrated in FIGS. 23 and 25 are configured to break away at the reduced diameter portion 1046′ upon disconnecting the battery connector 1004′ from the hybrid energy locomotive connector (not shown) during the unsafe event. As with the embodiments of the present invention discussed above, the inner housing 1010′ and the outer housing 1022′ are made from a non-conductive material. Additionally, the reduced diameter portion 1046′ is illustratively positioned adjacent to a back end 1050′ of the inner housing 1010′ of the battery connector 1004′. However, the reduced diameter portion may be positioned along any portion of the male connector (or female receptacle if female receptacles are positioned within the battery connector), provided that the reduced diameter portion is positioned sufficiently close to the back end of the inner housing such that the remaining male connector after the male connector breaks away at the reduced diameter portion is not exposed upon disconnecting the battery connector from the hybrid energy locomotive connector.

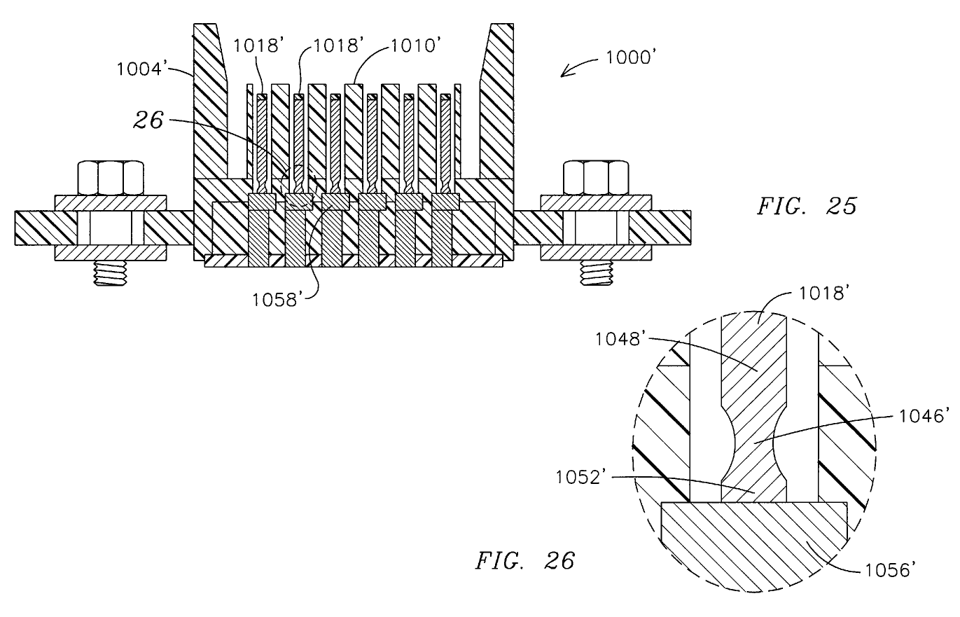

As illustrated in FIG. 22, for the system 1000 discussed in the previous embodiment, an unsafe event may arise when the respective battery connector 1004 and hybrid energy locomotive connector 1008 are connected, and the plurality of male connectors 1018 and female connectors of the respective battery connector 1004 and the hybrid energy locomotive connector subsequently fuse together. This may arise when a high current above a predetermined threshold passes through the plurality of male connectors 1018 and the female connectors, for example. Similarly, the plurality of male connectors 1018′ and female receptacles 1020′ may fuse together during such an unsafe event. As illustrated in FIGS. 23,25 and 26, upon disconnecting the battery connector 1004′ from the hybrid energy locomotive connector subsequent to the plurality of male connectors 1018′ and female receptacles fusing together, the male connectors 1018′ of the battery connector 1004′ are configured to break away at the reduced diameter portion 1046′, such that the a remaining portion 1052′ of the male connectors 1018′ remains unexposed within the inner housing 1010′ of the battery connector 1004′ upon disconnecting the battery connector 1004′ from the hybrid energy locomotive connector. As shown in FIG. 23, the outer housing 1022′ of the battery connector 1004′ is configured with a greater internal shear strength than the reduced diameter portion 1046′ such that the outer housing 1022′ remains intact during the break away of the male connectors 1018′ of the battery connector 1004′ at the reduced diameter portion 1046′. In calculating the internal shear strength of the outer housing of the battery connector, the number of the male connectors, and the internal shear strength of each male connector may be factored. As illustrated in FIG. 23, in addition to the remaining portion 1052′, a removed portion 1054′ of the male connectors 1018′ positioned opposite to the reduced diameter portion 1046′ from the remaining portion 1052′ is configured to remain within the inner housing of the hybrid energy locomotive connector upon disconnecting the battery connector 1004′. As illustrated in FIG. 26, the plurality of male connectors 1018′ of the battery connector 1004′ further includes an enlarged diameter portion 1056′ adjacent to the reduced diameter portion 1046′, where the enlarged diameter portion 1056′ is positioned within an enlarged diameter slot 1058′ within the inner housing 1010′ of the battery connector 1004′. The male connectors 1018′ (or female receptacles if the inner housing 1010′ includes female receptacles) are configured to be inserted into the inner housing 1010′ from the back end 1050′ such that the enlarged diameter portion 1056′ enters the enlarged diameter slot 1058′. Those elements of the system 1000′ not described herein and referenced in the drawings, are similar to those elements of the previous embodiments discussed above, with prime notation, and require no further discussion herein.

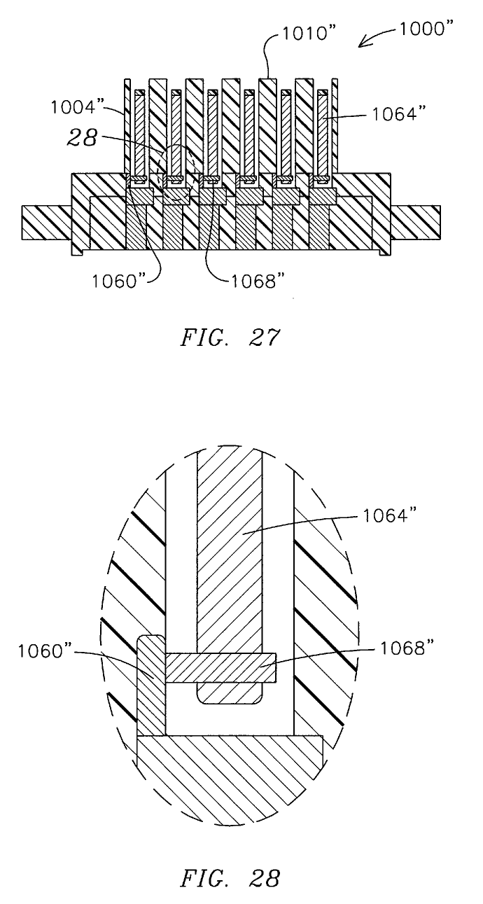

FIGS. 24, and 27-28 illustrate another exemplary embodiment of a system 1000″ including a battery connector 1004″. As illustrated in FIGS. 24, and 27-28, a plurality of first male connectors 1060″ are coupled to a respective plurality of second male connectors 1064″ through a respective plurality of fuse links 1068″. Although FIGS. 24, 27-28 illustrate a plurality of first male connectors and second male connectors, the battery connector may include a plurality of first female receptacles and second female receptacles, which are also respectively coupled with a plurality of fuse links. The plurality of second male connectors 1064″ are configured to break away from the inner housing 1010″, and the plurality of first male connectors 1060″ are configured to remain unexposed within the inner housing 1010″ upon disconnecting the battery connector 1004″ from the mounting connector during an unsafe event. As with the previous embodiments of the present invention, the inner housing 1010″ is made from a non-conductive material. In connecting the battery connector 1004″ with the hybrid energy locomotive connector, the plurality of second male connectors 1064″ connect with the plurality of female receptacles of the hybrid energy locomotive connector.

Each fuse link 1068″ is a conductive sheet mechanically compressed around a first male connector 1060″ and a second male connector 1064″ such that the fuse link 1068″ decouples the first and second male connectors 1060″,1064″ during an unsafe condition. For example, if the plurality of second male connectors 1064″ of the battery connector 1004″ and the plurality of female receptacles of the hybrid energy locomotive connector become fused together due to a high current, then upon disconnecting the battery connector 1004″ and the hybrid energy locomotive connector, a mechanical force may be exerted on the fuse link 1068″. As illustrated in FIG. 24, if such a mechanical force is in excess of a predetermined threshold, it would cause the fuse link 1068″ to decouple the first and second male connectors 1060″,1064″, and thus retain an unexposed plurality of first male connectors 1060″ within the inner housing 1010″ upon disconnecting the battery connector 1004″ from the hybrid energy locomotive connector 1008″. As further illustrated in FIG. 24, the plurality of second male connectors 1064″ will remain within the inner housing 1012″ of the hybrid energy locomotive connector 1008″. Those elements of the system 1000″ not described herein and referenced in the drawings, are similar to those elements of the previous embodiments discussed above, with double prime notation, and require no further discussion herein.

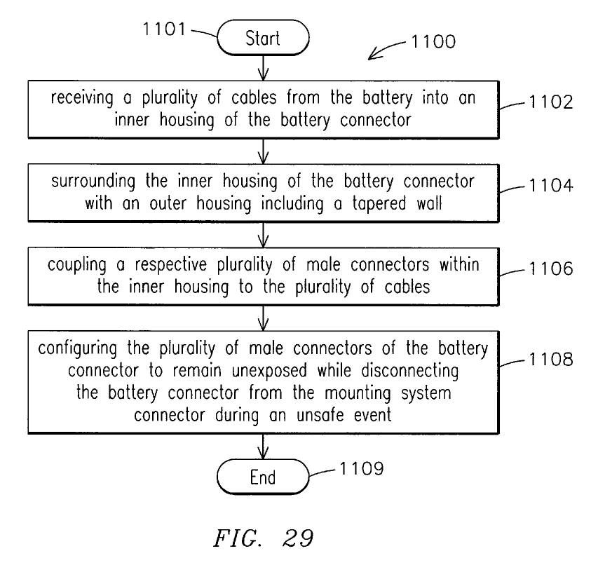

FIG. 29 illustrates an exemplary embodiment of a method 1100 for connecting a battery 1002 to a mounting system 1006. The method 1100 begins (block 1101) by receiving (block 1102) a plurality of cables 1014 from the battery 1102 into an inner housing 1010 of the battery connector 1004. The method 1100 further includes surrounding (block 1104) the inner housing 1010 of the battery connector 1004 with an outer housing 1022 including a tapered wall 1026. Subsequently, the method 1100 involves coupling (block 1106) a respective plurality of male connectors 1018 within the inner housing 1010 to the plurality of cables 1014. Additionally, the method 1100 includes configuring (block 1108) the plurality of male connectors 1018 of the battery connector 1004 to remain unexposed while disconnecting the battery connector 1004 from the mounting system connector 1008 during an unsafe event, before ending at block 1109.

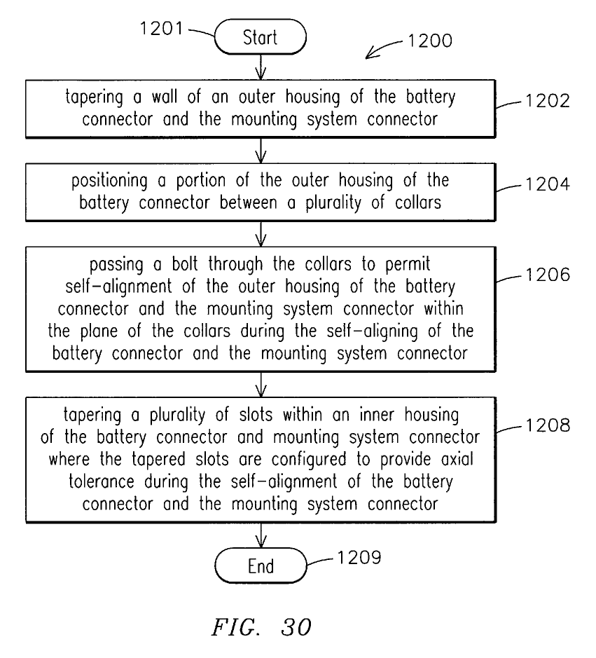

FIG. 30 illustrates an exemplary embodiment of a method 1200 for self-aligning a battery connector 1004 to a mounting system connector 1008 during connecting the battery connector 1004 and the mounting system connector 1008. The method 1200 begins (block 1201) by tapering (block 1202) a wall 1026,1028 of an outer housing 1022,1024 of the battery connector 1004 and the mounting system connector 1008. The tapered walls 1026,1028 have a respective tapered inner surface and tapered outer surface configured to self-align upon connecting the battery connector 1004 and the mounting system connector 1008. The method 1200 further includes positioning (block 1204) a portion 1038,1040 of the outer housing 1022 of the battery connector 1004 between a plurality of collars 1034. The method 1200 further includes passing (block 1206) a bolt 1036 through the collars 1034 to permit self-alignment of the outer housing 1022,1024 of the battery connector 1004 and the mounting system connector 1008 within the plane of the collars 1034 during the self-aligning of the battery connector 1004 and the mounting system connector 1008. The method 1200 further includes tapering (block 1208) a plurality of slots 1042,1044 within an inner housing 1010,1012 of the battery connector 1004 and mounting system connector 1008, where the tapered slots 1042,1044 are configured to provide axial tolerance during the self-alignment of the battery connector 1004 and the mounting system connector 1008, before ending at 1209.

This written description uses examples to disclose embodiments of the invention, including the best mode, and also to enable any person skilled in the art to make and use the embodiments of the invention. The patentable scope of the embodiments of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

That which is claimed is:

1. A system for connecting a battery to a mounting system, said battery coupled to a battery connector, said mounting system coupled to a mounting system connector, said system comprising:
an inner housing of said battery connector configured to receive a plurality of cables from said battery;
a respective plurality of male connectors or female receptacles positioned within said inner housing of said battery connector and coupled to said plurality of cables, said plurality of male connectors or female receptacles configured to remain unexposed upon disconnecting said battery connector from said mounting connector during an unsafe event; and
an outer housing of said battery connector surrounding said inner housing, said outer housing comprising a tapered wall.

2. The system according to claim 1, wherein said inner housing and outer housing are made from a non-conductive material, said mounting system is a hybrid energy locomotive, and said mounting system connector is a hybrid energy locomotive connector comprising:
an inner housing configured to receive a plurality of cables from said hybrid energy locomotive;
a respective plurality of male connectors or female receptacles positioned within said inner housing of said hybrid energy locomotive connector and coupled to said plurality of cables from said hybrid energy locomotive; said respective plurality of male connectors or female receptacles being configured to connect with said respective plurality of male connectors or female receptacles within said inner housing of said battery connector; and
an outer housing surrounding said inner housing, said outer housing comprising a tapered wall;
said respective tapered walls of said battery connector outer housing and said hybrid energy locomotive connector outer housing comprise a respective male or female tapered wall, said male tapered wall having a tapered outer surface, said female tapered wall having a tapered inner surface; said respective male and female tapered walls configured to self-align said battery connector and said hybrid energy locomotive connector upon connecting said battery connector and said hybrid energy locomotive connector.

3. The system according to claim 2, wherein said battery connector and hybrid energy locomotive connector each further comprise a plurality of collars and a plurality of bolts, a portion of said outer housing of said hybrid energy locomotive connector and said battery connector being positioned between said plurality of collars such that one of said plurality of bolts is passed through said plurality of collars and said portion of said outer housing to restrict movement of said outer housing of said hybrid energy locomotive connector and battery connector within the plane of said plurality of collars during said self-alignment of said battery connector and said hybrid energy locomotive connector.

4. The system according to claim 3, wherein said inner housing of said hybrid energy locomotive connector and said battery connector comprises a plurality of tapered slots to hold said respective plurality of male connectors or female receptacles; said tapered slots are configured to provide axial tolerance during said self-alignment of said battery connector and said hybrid energy locomotive connector subsequent to said self-alignment provided by said respective male and female tapered walls of said outer housing and said movement of said outer housing along said plane of said collars.

5. The system according to claim 4, wherein said inner housing tapered slots of said hybrid energy locomotive connector and said battery connector respectively comprise male convex slots or female concave slots.

6. The system according to claim 4, wherein during connecting said battery connector and said hybrid energy locomotive connector, said inner housing of said battery connector and said hybrid energy locomotive connector is configured to move and self-align independent of said respective outer housing of said battery connector and said hybrid energy locomotive connector; said inner housing and said outer housing being configured to self-align to overcome axial and tilt variations.

7. The system according to claim 1, wherein said respective plurality of male connectors or female receptacles comprise a reduced diameter portion, said reduced diameter portion configured with a lower shear strength relative to an unreduced diameter portion of said respective plurality of male connectors or female receptacles; said male connectors or female receptacles configured to break away at said reduced diameter portion upon disconnecting said battery connector from said mounting system connector during said unsafe event.

8. The system according to claim 7, wherein said inner housing and said outer housing are made from a non-conductive material; said reduced diameter portion is positioned adjacent to a back end of said inner housing of said battery connector, said mounting system is a hybrid energy locomotive, said mounting system connector is a hybrid energy locomotive connector comprising:
an inner housing configured to receive a plurality of cables from said hybrid energy locomotive;
a respective plurality of male connectors or female receptacles positioned within said inner housing of said hybrid energy locomotive connector and coupled to said cables from said hybrid energy locomotive, said respective plurality of male connectors or female receptacles configured to connect with said respective plurality of male connectors or female receptacles within said inner housing of said battery connector, and
an outer housing surrounding said inner housing, said outer housing comprising a tapered wall;
wherein during said unsafe condition, said respective plurality of male connectors and female connectors of said hybrid energy locomotive connector and battery connector fuse together.

9. The system according to claim 8, wherein upon disconnecting said battery connector from said hybrid energy locomotive connector subsequent to fusing said plurality of male connectors and female receptacles together, said male connectors or female receptacles of said battery connector are configured to break away at said reduced diameter portion, such that said a remaining portion of said male connectors or female receptacles remain unexposed within said inner housing of said battery connector upon disconnecting said battery connector from said hybrid energy locomotive connector.

10. The system according to claim 9, wherein said outer housing of said battery connector is configured with a greater internal shear strength than said reduced diameter portion such that said outer housing remains intact during said break away of said male connectors or female receptacles of said battery connector at said reduced diameter portion.

11. The system according to claim 9, further comprising a removed portion of said male connectors or female receptacles of said battery connector opposite said reduced diameter portion from said remaining portion, said removed portion configured to remain within said inner housing of said hybrid energy locomotive connector upon disconnecting said battery connector.

12. The system according to claim 9, wherein said plurality of male connectors or female receptacles of said battery connector further comprises an enlarged diameter portion adjacent said reduced diameter portion, said enlarged diameter portion positioned within an enlarged diameter slot within said inner housing of said battery connector, said male connectors or female receptacles configured to be inserted into said inner housing from said back end such that said enlarged diameter portion enters said enlarged diameter slot.

13. A system for connecting a battery to a mounting system, said battery coupled to a battery connector, said mounting system coupled to a mounting system connector, said system comprising:
an inner housing of said battery connector configured to receive a plurality of cables from said battery;
a respective plurality of first male connectors or first female receptacles coupled to said plurality of cables and positioned adjacent to a back end of said inner housing of said battery connector, said plurality of first male connectors or first female receptacles coupled to a respective plurality of second male connectors or second female receptacles through a respective plurality of fuse links, said plurality of second male connectors or second female receptacles configured to break away from said inner housing, and said plurality of first male connectors or first female receptacles configured to remain unexposed upon disconnecting said battery connector from said mounting connector during an unsafe event; and
an outer housing of said battery connector surrounding said inner housing, said outer housing comprising a tapered wall.

14. The system according to claim 13, wherein said inner housing and outer housing are made from a non-conductive material; said mounting system is a hybrid energy locomotive, said mounting system connector is a hybrid energy locomotive connector comprising:
an inner housing configured to receive a plurality of cables from said hybrid energy locomotive,
a respective plurality of male connectors or female receptacles positioned within said inner housing of said hybrid energy locomotive connector and coupled to said cables from said hybrid energy locomotive, said respective plurality of male connectors or female receptacles configured to connect with said respective plurality of second male connectors or second female receptacles within said inner housing of said battery connector, and
an outer housing surrounding said inner housing, said outer housing comprising a tapered wall;
wherein during said unsafe condition, said plurality of male connectors or female connectors of said hybrid energy locomotive connector and said respective plurality of second male connectors or plurality of second female receptacles of said battery connector fuse together.

15. The system according to claim 14, wherein each fuse link comprises a conductive sheet mechanically compressed around said plurality of first male connectors or first female receptacles and said plurality of second male connectors or second female receptacles such that said fuse link decouples said plurality of first male connectors or first female receptacles and said plurality of second male connectors or second female receptacles during said unsafe condition.

16. The system according to claim 15, wherein said unsafe condition arises upon said respective plurality of male connectors or female connectors of said hybrid energy locomotive connector and said respective plurality of second male connector or second female receptacles of said battery connector fusing together such that upon disconnecting said battery connector and said hybrid energy locomotive connector, a mechanical force is exerted on said fuse link greater than a predetermined threshold.

17. The system according to claim 16, wherein said unsafe condition further arises upon a current greater than a predetermined threshold passing through said fuse link to cause said fuse link to decouple said plurality of first male connectors or first female receptacles and said plurality of second male connectors or second female receptacles.

18. The system according to claim 15, wherein upon disconnecting said hybrid energy locomotive connector from said battery connector during said unsafe condition, said plurality of second male connectors or second female receptacles remain within said inner housing of said hybrid energy locomotive connector.

19. The system according to claim 1, further comprising a seal surrounding a plurality of openings adjacent a back end of said inner housing of said battery connector to receive said plurality of cables from said battery; said seal configured to form an interface between said battery connector and said battery.

20. The system according to claim 19, wherein said seal is made from a non-conductive elastomer material, configured to surround said openings adjacent to said back end, said seal being further configured to protrude at each opening away from said back end, each protrusion configured to receive one of said plurality of male connectors or female receptacles.

21. The system according to claim 20, said seal configured to provide a sealed interface at said back end of said battery connector, said seal further configured to provide a sealed interface between said outer housing and said battery.

22. The system according to claim 19, further comprising:
a non-conductive cap covering an end of each of said plurality of male connectors or female receptacles opposite said back end of said inner housing;
said cap rigidly secured to an external surface of said male connector or an inner surface of said female receptacle; and
a non-conductive jacket surrounding said plurality of male connectors or female receptacles, said jacket positioned within a gap surrounding said plurality of male connectors or female receptacles.

23. The system according to claim 22, said non-conductive cap is made from a ceramic non-conductive material, said non-conductive cap is rigidly glued to said external surface or inner surface of said respective male connector or female receptacle; said non-conductive jacket is a plastic jacket surrounding said plurality of male connectors or female receptacles, said respective male connectors and female receptacles of said battery connector and said hybrid energy locomotive connector are configured to connect at a middle portion beyond said non-conductive cap.

24. A method for connecting a battery to a mounting system, said battery coupled to a battery connector, said mounting system coupled to a mounting system connector, said method comprising:
receiving a plurality of cables from said battery into an inner housing of said battery connector;
surrounding said inner housing of said battery connector with an outer housing comprising a tapered wall;
coupling a respective plurality of male connectors or female receptacles within said inner housing to said plurality of cables; and
configuring said plurality of male connectors or female receptacles of said battery connector to remain unexposed while disconnecting said battery connector from said mounting connector during an unsafe event.

25. A method for self-aligning a battery connector to a mounting system connector during connecting said battery connector and said mounting system connector, said method comprising:
tapering a wall of an outer housing of said battery connector and said mounting system connector, said tapered wall having a respective tapered outer surface or tapered inner surface configured to self-align upon connecting said battery connector and said mounting system;
positioning a portion of said outer housing of said battery connector between a plurality of collars;
passing a bolt through said collars to permit self-alignment of said outer housing of said battery connector and said mounting system within the plane of said collars during said self-aligning of said battery connector and said mounting system; and
tapering a plurality of slots within an inner housing of said battery connector and hybrid energy locomotive connector, said tapered slots being configured to provide axial tolerance during said self-alignment of said battery connector and said hybrid energy locomotive connector.
